(19) United States
(12) Patent Application Publication
(10) Pub. No.: US 2024/0324603 A1
(43) Pub. Date: Oct. 3, 2024

(54) MICROALGAE-BASED BIOPROTECTION COMPOSITIONS AND METHODS FOR HOST PLANTS

(71) Applicant: AE Agribiologicals S.L., Madrid (ES)

(72) Inventors: Xing Liang LIU, Davis, CA (US); Carmela Perez CALLEJA, Oviedo (ES); Douglas Ry WAGNER, Pleasant Hill, OR (US)

(21) Appl. No.: 18/673,160

(22) Filed: May 23, 2024

Related U.S. Application Data
(63) Continuation of application No. PCT/EP2022/083064, filed on Nov. 23, 2022.
(60) Provisional application No. 63/283,184, filed on Nov. 24, 2021.

(51) Int. Cl. A01N 65/03; A01N 25/14; A01P 3/00

(52) U.S. Cl. CPC A01N 65/03; A01N 25/14; A01P 3/00

(57) ABSTRACT

The present disclosure is related to plant bioprotection compositions comprising microalgae components. The disclosure also provides methods of using the bioprotection compositions, e.g., for suppressing, delaying, or treating pathogen infection within host plants.

### CROSS-REFERENCE TO RELATED APPLICATIONS

This application claims the benefit of and priority to U.S. Provisional Patent Application No. 63/283,184, filed on Nov. 24, 2021, the contents of which are herein incorporated by reference in their entirety.

### FIELD OF THE DISCLOSURE

The present disclosure relates to novel bioprotection compositions comprising microalgae and methods of use thereof. The present compositions may be used for bioprotection and for improving host plant immunity.

### BACKGROUND

The widespread use of agrochemicals has led to increased levels of agricultural productivity. However, the excessive use of these agrochemicals, particularly pesticides, can result in detrimental effects on soil health and the environment. As such, there is a growing need for environmentally safe and sustainable alternatives to improve plant health and productivity without harm to the soil or environment. Of interest for these applications are biological control agents, also referred to as bioprotection agents.

There is a growing and unmet demand for ecologically safe and sustainable bioprotection compositions and methods.

### BRIEF SUMMARY

In one aspect, the present disclosure provides a method of bioprotection, the method comprising the step of: a) applying a microalgae-based composition to a host plant.

In some embodiments, the method improves host plant immunity.

In some embodiments, the method upregulates the production of a gene involved in host plant immunity.

In one aspect, the present disclosure provides a method for improving host plant immunity against fungal infection, the method comprising the step of: a) applying a microalgae-based composition to the host plant.

In one aspect, the present disclosure provides a method for upregulating a host plant immune response against pathogenic infection a) applying a microalgae-based composition to the host plant.

In some embodiments, the composition induces differential gene expression in juvenile versus mature host plants.

In some embodiments, the composition is applied to a juvenile host plant.

In some embodiments, the composition is applied to a juvenile host plant and induces upregulation of genes involved in cell division.

In some embodiments, the composition is applied to a mature host plant.

In some embodiments, the composition is applied to a mature host plant and induces upregulation of genes involved in response to stimulus and/or metabolic processes.

In some embodiments, the method upregulates the plant host's Systemic Acquired Resistance (“SAR”).

In some embodiments, the method upregulates the expression of genes involved in pipecolic acid biosynthesis.

In some embodiments, the microalgae-based composition does not have pathogenicidal activity.

In some embodiments, the microalgae-based composition does not have fungicidal activity.

In some embodiments, the infection is caused by a fungus, bacterium, protist, or virus.

In some embodiments, the infection is caused by a fungus.

In some embodiments, the infection is caused by a pathogen from a genus selected from the list consisting of: Albugo, Alternaria, Aphanomyces, Aschochyta, Aspergillus, Bipolaris, Blumeria, Botrytis, Cercospora, Colletotrichum, Didymella, Erysiphe, Fusarium, Leptosphaeria, Magnaporthe, Melampsora, Microdochium, Mycosphaerella, Peronospora, Phakopsora, Phytophthora, Plasmodiophora, Plasmopara, Puccinia, Pyrenophora, Pythium, Rhizoctonia, Rhizopus, Septoria, Sclerotium, Stemphylium, Tilletia, Uromyces, Ustilago, and Venturia.

In some embodiments, the infection is caused by Ascochyta rabei, Alternaria carthami, Bipolaris sorokiana, Botrytis cinerea, Pyrenophora teres, or Rhizopus stolonifer.

In some embodiments, the infection is in any plant part of the host plant.

In some embodiments, the infection is in a root, leaf, fruit, or grain of the plant host.

In some embodiments, the method suppresses or delays progression of the infection.

In some embodiments, the method suppresses or delays progression of infection, as measured via an infection parameter selected from the list consisting of: size of necrotic tissue, lesion size, percent infection per leaf, percent infection per plant, and number of leaves infected per plant.

In some embodiments, the method suppresses or delays progression of infection, as measured in comparison to a control plant without application of the microalgae composition.

In some embodiments, the method comprises the additional step of: applying a fungicide and/or antibacterial to the host plant, separately or in combination with the microalgae-based composition.

In some embodiments, the composition comprises multiple species of microalgae.

In some embodiments, the composition comprises microalgae from a phylum selected from the list consisting of: Chlorophyta, Cryptophyta, Cyanophyta, Euglenophyta, Heterokontophyta, or Rhodophyta.

In some embodiments, the composition comprises microalgae from a genus selected from the list consisting of: Chlorella, Scenedesmus, Nannochloropsis, Muriellopsis, Isochrysis, Tisochrysis, Desmodesmus, Haematococcus, Arthrospira, and Anabaena.

In some embodiments, the composition comprises whole-cell microalgae powder.

In some embodiments, the composition comprises 0.1-50 g/L of whole-cell microalgae powder.

In some embodiments, the composition comprises 0.8-20 g/L of whole-cell microalgae powder.

In some embodiments, the composition comprises digested microalgae solution (“DMS”).

In some embodiments, the composition comprises 0.3-0.5% v/v DMS.

In some embodiments, the composition comprises DMS, and the DMS comprises 5-20% dry matter of microalgae.

In some embodiments, the composition comprises DMS, and the DMS comprises 5-20% dry matter of microalgae, and wherein the composition comprises DMS diluted to 0.3-0.5% v/v.

In some embodiments, the composition is a liquid, and wherein the composition is applied at a rate of 0.5-20 L/ha.

In some embodiments, the composition is a liquid, and wherein the composition is applied at a rate of 1-10 L/ha.

In some embodiments, the composition is a granule composition, and wherein the composition is applied at a rate of 1-20 kg/ha.

In some embodiments, the composition is a granule composition, and wherein the composition is applied at a rate of 5-15 kg/ha.

In some embodiments, the host plant is an agronomical crop, a horticultural crop, or an ornamental crop.

In some embodiments, the host plant is a monocot or dicot.

In some embodiments, the host plant is an agronomical crop, a horticultural crop, or an ornamental plant.

In some embodiments, the composition is a liquid and is applied to the whole plant, a plant part, and/or a plant cell.

In some embodiments, the composition is applied as a spray to aerial plant parts and/or as a soil treatment to plant roots.

In some embodiments, the composition comprises a cell free supernatant (“CFS”) of a microbial culture.

In some embodiments, the composition comprises a CFS, and wherein the CFS is the isolated CFS of a mixed microbial culture comprising one or more microorganisms selected from the list consisting of: Aspergillus spp., Bacillus spp., Rhodopseudomonas spp., Candida spp., Lactobacillus spp., Lactococcus spp., Pseudomonas spp., Saccharomyces spp., Streptococcus spp., and combinations thereof.

In some embodiments, the composition comprises a CFS, and wherein the CFS is the isolated CFS of a mixed microbial culture obtained from culturing IN-M1, deposited under ATCC Accession No. PTA-12383, or IN-M2, deposited under ATCC Accession No. PTA-121556.

In some embodiments, the composition comprises a CFS, and wherein the CFS comprises at least 2500 micrograms potassium per gram, at least 435 micrograms nitrogen per gram, at least 475 micrograms calcium per gram, and/or at least 200 micrograms magnesium per gram.

In some embodiments, the composition comprises a CFS, and wherein the CFS comprises a CFS of a mixed microbial culture that has been diluted between 1:50 and 1:2000 with water.

In some embodiments, the composition comprises a CFS, and wherein the CFS comprises about 2% dry matter.

In some embodiments, the composition comprises a CFS, and wherein the composition comprises about 0.005-0.05% w/w CFS dry matter.

In some embodiments, the composition comprises a CFS, and wherein the composition comprises microalgae in the form of DMS, and wherein the ratio of DMS to CFS is between 1:4 and 4:1.

In some embodiments, the composition comprises a CFS, and wherein the composition comprises microalgae in the form of DMS, wherein the ratio of DMS to CFS is between 1:4 and 4:1, and wherein the composition comprises the combination of DMS and CFS diluted to 0.3-0.5% v/v in water.

In some embodiments, the composition comprises a CFS, and wherein the composition comprises microalgae in the form of DMS, and wherein the ratio of DMS to CFS is 1:4 or 2:3.

In one aspect, the present disclosure provides a bioprotection composition comprising: a) a microalgae-based composition; and b) a pathogenicidal agent.

In some embodiments, the composition comprises a pesticide, fungicide, insecticide, herbicide, nematicide, bactericide, or antimicrobial.

In some embodiments, the composition comprises a fungicide.

In some embodiments, the composition comprises a microbial agent that has pathogenicidal properties.

In some embodiments, the composition comprises a cell free supernatant (“CFS”) of a microbial culture.

In some embodiments, the composition comprises a CFS, and wherein the CFS is the isolated CFS of a mixed microbial culture comprising one or more microorganisms selected from the list consisting of: Aspergillus spp., Bacillus spp., Rhodopseudomonas spp., Candida spp., Lactobacillus spp., Lactococcus spp., Pseudomonas spp., Saccharomyces spp., Streptococcus spp., and combinations thereof.

In some embodiments, the composition comprises a CFS, and wherein the CFS is the isolated CFS of a mixed microbial culture obtained from culturing IN-M1, deposited under ATCC Accession No. PTA-12383, or IN-M2, deposited under ATCC Accession No. PTA-121556.

In some embodiments, the composition comprises a CFS, and wherein the CFS comprises at least 2500 micrograms potassium per gram, at least 435 micrograms nitrogen per gram, at least 475 micrograms calcium per gram, and/or at least 200 micrograms magnesium per gram.

In some embodiments, the composition comprises a CFS, and wherein the CFS comprises a CFS of a mixed microbial culture that has been diluted between 1:50 and 1:2000 with water.

In some embodiments, the composition comprises a CFS, and wherein the CFS comprises about 2% dry matter.

In some embodiments, the composition comprises a CFS, and wherein the composition comprises about 0.005-0.05% w/w CFS dry matter.

In some embodiments, the composition comprises a CFS, and wherein the composition comprises microalgae in the form of DMS, and wherein the ratio of DMS to CFS is between 1:4 and 4:1.

In some embodiments, the composition comprises a CFS, and wherein the composition comprises microalgae in the form of DMS, wherein the ratio of DMS to CFS is between 1:4 and 4:1, and wherein the composition comprises the combination of DMS and CFS diluted to 0.3-0.5% v/v in water.

In some embodiments, the composition comprises a CFS, and wherein the composition comprises microalgae in the form of DMS, and wherein the ratio of DMS to CFS is 1:4 or 2:3.

In some embodiments, the composition comprises multiple species of microalgae.

In some embodiments, the composition comprises microalgae from a phylum selected from the list consisting of: Chlorophyta, Cryptophyta, Cyanophyta, Euglenophyta, Heterokontophyta, or Rhodophyta.

In some embodiments, the composition comprises microalgae from a genus selected from the list consisting of: Chlorella, Scenedesmus, Nannochloropsis, Muriellopsis, Isochrysis, Tisochrysis, Desmodesmus, Haematococcus, Arthrospira, and Anabaena.

In some embodiments, the composition comprises whole-cell microalgae powder.

In some embodiments, the composition comprises 0.1-50 g/L of whole-cell microalgae powder.

In some embodiments, the composition comprises 0.8-20 g/L of whole-cell microalgae powder.

In some embodiments, the composition comprises digested microalgae solution (“DMS”).

In some embodiments, the composition comprises 0.3-0.5% v/v DMS.

In some embodiments, the composition comprises DMS, and the DMS comprises 5-20% dry matter of microalgae.

In some embodiments, the composition comprises DMS, and the DMS comprises 5-20% dry matter of microalgae, and wherein the composition comprises DMS diluted to 0.3-0.5% v/v.

In one aspect, the present disclosure provides a bioprotection method comprising applying the composition of any one of the foregoing embodiments to a host plant.

### BRIEF DESCRIPTION OF THE SEVERAL VIEWS OF THE DRAWINGS

FIG. 1A shows a nutrient analysis of an illustrative digested microalgae solution (“DMS”) of the disclosure. FIG. 1B shows a nutrient analysis of an illustrative liquid composition of the present disclosure comprising 79% DMS and 21% cell free supernatant (“CFS”) of a microbial culture. FIG. 1C shows a nutrient analysis of an illustrative liquid composition of the present disclosure comprising 50% DMS and 50% CFS. FIG. 1D shows a nutrient analysis of an illustrative liquid composition of the present disclosure comprising 40% DMS and 60% CFS. FIG. 1E shows a nutrient analysis of an illustrative liquid composition of the present disclosure comprising 30% DMS and 70% CFS. FIG. 1F shows a nutrient analysis of an illustrative CFS of the disclosure.

FIG. 2A shows results from a non-wounded assay with Botrytis cinerea fungal exposure on DMS-treated and untreated grapes. FIG. 2B shows the results of a wounded assay with Botrytis cinerea infection in DMS-treated wounded grapes compared to the untreated control. FIG. 2C shows an image of exemplary symptoms at day 3 for a sampling of treated and untreated grapes. FIG. 2D shows a graph of number of infected fruit in treated and control grapes. FIG. 2E shows a graph of lesion size of infected fruit in treated and control grapes.

FIG. 3A shows exemplary leaves from untreated control safflower plants exposed to Alternaria infection. FIG. 3B shows exemplary leaves from DMS-treated safflower plants exposed to Alternaria infection. For control and DMS-treated safflower plants, FIG. 3C shows percent infection per leaf, FIG. 3D shows percent infection per plant, and FIG. 3E shows number of infected leaves per plant.

FIG. 4A shows untreated leaves of 3-week old safflower plants and FIG. 4B shows treated leaves of 3-week old safflower plants.

FIG. 5A shows untreated leaves of 8-week old safflower plants and FIG. 5B shows treated leaves of 8-week old safflower plants.

FIG. 6 shows images of a detached leaf fungal infection assay in Siberian tomato leaves.

FIG. 7 shows exemplary images from a whole plant fungal infection assay in Siberian tomato plants.

FIG. 8A shows an image of untreated Siberian tomato plant leaves. FIG. 8B shows an image of DMS-treated Siberian tomato plant leaves. FIG. 8C shows the results of lesion size in untreated and treated Siberian tomato plant leaves.

FIG. 9A shows an image of almonds in a fungal infection assay. FIG. 9B shows a table of results for a fungal infection assay in almonds.

FIG. 10A shows the number of tillers and number of infected leaves in rice plants treated with a DMS plus mycorrhizae combination composition compared to control untreated rice plants. FIG. 10B shows images of flag leaves and overall growth in untreated and treated rice plants.

FIG. 11 shows results of in vitro fungal assays testing DMS against three fungal pathogens.

FIG. 12A shows overall transcriptomic changes in both juvenile and mature Arabidopsis plants at both 2 and 24 hour time points. FIG. 12B shows example categories of genes upregulated and downregulated in juvenile and mature Arabidopsis plants at both 2 and 24 hour time points. FIG. 12C shows examples of genes upregulated in juvenile plants at 2 hours. FIG. 12D shows additional examples of genes upregulated in juvenile plants at 2 hours. FIG. 12E shows shared upregulated genes between juvenile and mature plants shown using the values for mature plants. FIG. 12F shows the expression of pipecolic acid biosynthesis genes across all Arabidopsis treatment conditions.

FIG. 13A shows an overview of the pipecolic acid biosynthesis pathway and its relationship to systemic acquired resistance (SAR). FIG. 13B shows the acquisition of SAR following pathogen challenge in a naïve plant. FIG. 13C shows additional signaling molecules related to the induction of SAR after pathogen exposure in plant tissue.

### DETAILED DESCRIPTION

### Definitions

The term “a” or “an” refers to one or more of that entity, i.e. can refer to plural referents. As such, the terms “a,” “an,” “one or more,” and “at least one” are used interchangeably herein. In addition, reference to “an element” by the indefinite article “a” or “an” does not exclude the possibility that more than one of the elements is present, unless the context clearly requires that there is one and only one of the elements.

Throughout this application, the term “about” is used to indicate that a value includes the inherent variation of error for the device or the method being employed to determine the value, or the variation that exists among the samples being measured. Unless otherwise stated or otherwise evident from the context, the term “about” means within 15% above or below the reported numerical value (except where such number would exceed 100% of a possible value or go below 0%). When used in conjunction with a range or series of values, the term “about” applies to the endpoints of the range or each of the values enumerated in the series, unless otherwise indicated. As used in this application, the terms “about” and “approximately” are used as equivalents.

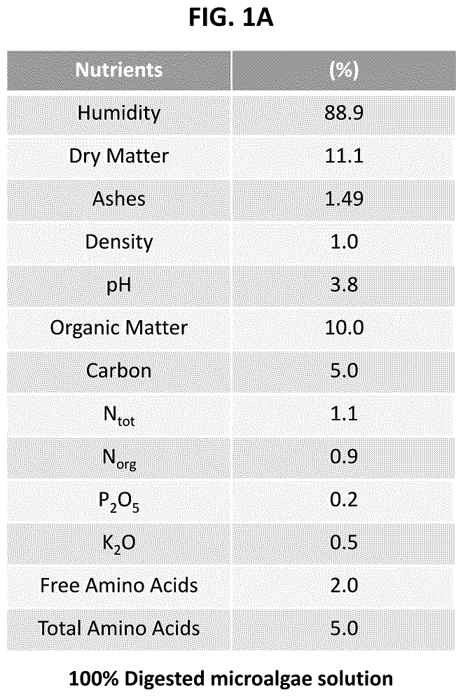

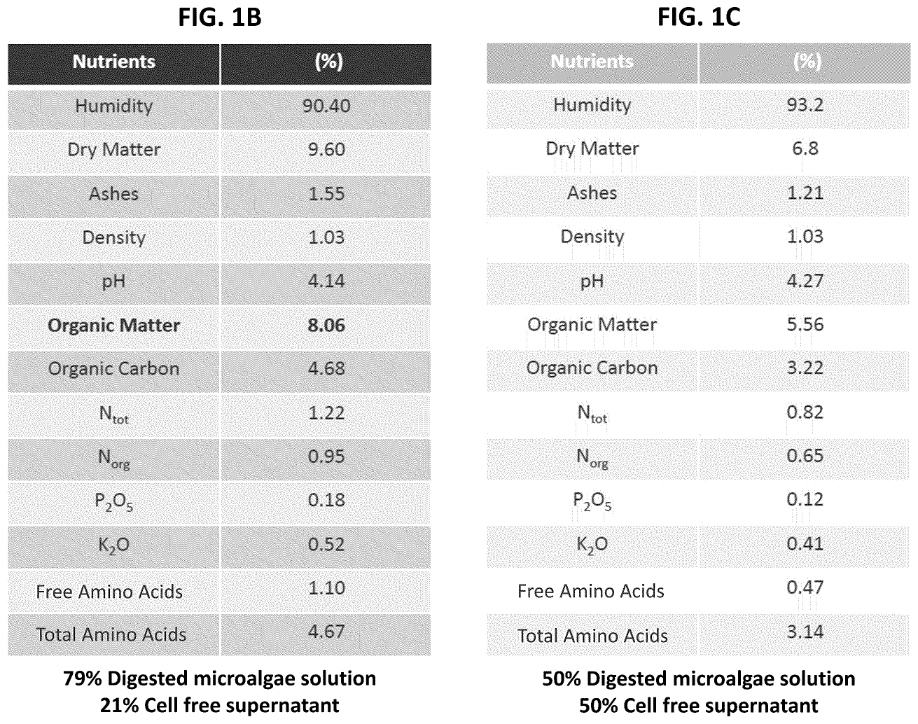

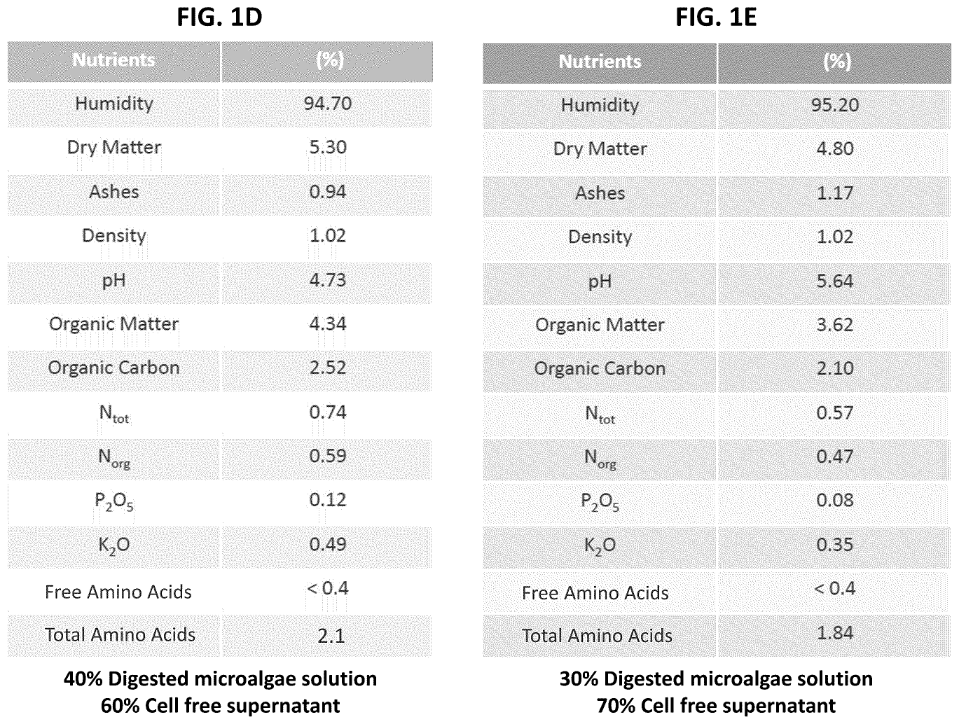

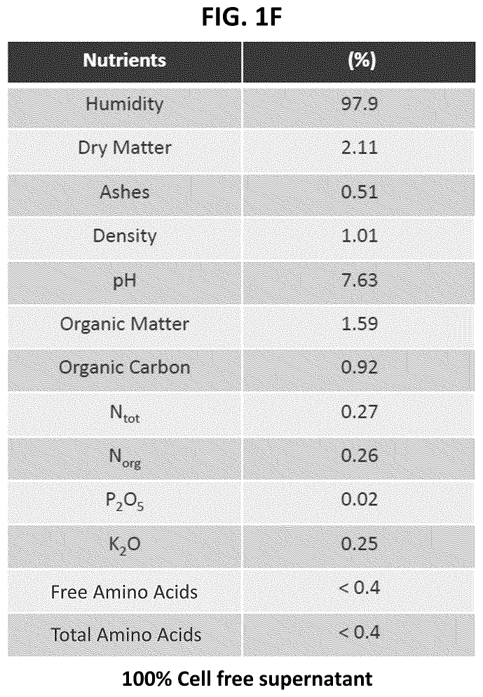

As used herein, “microalgae” are eukaryotic microbial organisms that contain a chloroplast or other plastid, and optionally, are capable of performing photosynthesis and prokaryotic microbial organisms capable of performing photosynthesis. Microalgae include obligate photoautotrophs, which are organisms that use light energy (e.g. from sunlight or other light source) to convert inorganic materials into organic materials for use in cellular functions such as biosynthesis and respiration. Microalgae also include heterotrophs, which can live solely off of a fixed carbon source. Microalgae include unicellular organisms that separate from sister cells shortly after cell division, as well as microbes such as, for example, Volvox, which is a simple multicellular photosynthetic microbe of two distinct cell types. Microalgae also include other microbial photosynthetic organisms that exhibit cell-cell adhesion, such as Agmenellum, Anabaena, and Pyrobotrys. In some embodiments, the microalgae of the present disclosure are selected from the phyla Chlorophyta, Cryptophyta, Cyanophyta, Euglenophyta, Heterokontophyta, and Rhodophyta. In some embodiments, the microalgae of the present disclosure are selected from the genera Chlorella, Scenedesmus, Nannochloropsis, Muriellopsis, Isochrysis, Tisochrysis, Desmodesmus, Haematococcus, Arthrospira, and Anabaena. As used in this description, the term microalgae encompasses any form of microalgae, whether in a natural and unprocessed whole state, dried, extracted, or otherwise processed. In some embodiments, the term “microalgae” is used to refer to a lysed, hydrolyzed, digested, pulverized, or otherwise processed form of microalgae. In some embodiments, microalgae used in the compositions herein has the nutrient analysis depicted in FIG. 1A. In some embodiments, microalgae is not macroalgae. In some embodiments, microalgae as used in the present compositions is not live microalgae.

As used herein, a “composition comprising microalgae” or “microalgae composition” refers to a composition comprising microalgae-derived components. Compositions comprising microalgae according to the present disclosure comprise, e.g., dried whole cell microalgae and/or lysed and digested microalgae. “Whole cell microalgae powder” refers to microalgae that has been dried and ground after being harvested. “Digested microalgae solution” or “DMS” refers to microalgae that has been dried, ground, and then processed to degrade cell walls and release peptides and other nutrients. DMS can be formulated using chemical, physical, or biological means to degrade cell walls and release peptides. As used herein, “microalgae dry matter” or “dry matter of microalgae” refers to the non-liquid content of a composition comprising microalgae.

As used herein, the terms “mycorrhiza” and “mycorrhizae” refer to mycorrhizal fungi. A mycorrhiza is a mutual symbiotic association between a fungus and a plant and the term is also used herein to refer to the fungus itself. “Ectomycorrhizae” is used to refer to mycorrhizal fungi that colonize host plant root tissues extracellularly. “Endomycorrhizae” is used to refer to mycorrhizal fungi that colonize host plant tissues intracellularly. In some embodiments, the compositions of the present disclosure comprise both ectomycorrhizae and endomycorrhizae. In some embodiments, the compositions of the present disclosure comprise predominantly endomycorrhizae, e.g., more than 90% endomycorrhizae.

As used herein, a “granule” refers to a dry, granular composition having an average diameter of less than about 1 cm for administration to agricultural crops.

As used herein, a “seed coating” refers to a composition applied to the seeds of an agricultural crop before or during planting.

As used herein, an “agricultural crop” refers to any plant that is harvested for commercial purposes. Agricultural crops include agronomic crops, horticultural crops, and ornamental plants. “Agronomic crops” are those that occupy large acreage and are the bases of the world's food and fiber production systems, often mechanized. Examples are wheat, rice, corn, soybean, alfalfa and forage crops, beans, sugar beets, canola, and cotton. “Horticultural crops” are used to diversify human diets and enhance the living environment. Vegetables, fruits, flowers, ornamentals, and lawn grasses are examples of horticultural crops and are typically produced on a smaller scale with more intensive management than agronomic crops. “Ornamental plants” are grown for decoration and include flowers, shrubs, grasses, and trees. Agricultural crops include both monocots and dicots. Monocots include most of the bulbing plants and grains, including agapanthus, asparagus, bamboo, bananas, corn, daffodils, garlic, ginger, grass, lilies, onions, orchids, rice, sugarcane, tulips, and wheat. Dicots include many garden flowers and vegetables, including legumes, the cabbage family, and the aster family. Examples of dicots are apples, beans, broccoli, carrots, cauliflower, cosmos, daisies, peaches, peppers, potatoes, roses, sweet pea, and tomatoes. Agricultural crops also include food crops, feed crops, cereal crops, oil seed crop, pulses, fiber crops, sugar crops, forage crops, medicinal crops, root crops, tuber crops, vegetable crops, fruit crops, and garden crops. The terms “host plant” and “agricultural crop” are used interchangeably herein.

As used herein, the term “carrier” is intended to include an “agronomically acceptable carrier.” An “agronomically acceptable carrier” is intended to refer to any material which can be used to deliver a composition as described herein, alone or in combination with one or more agriculturally beneficial ingredient(s), and/or biologically active ingredient(s), to a plant, a plant part (e.g., a leaf or a seed), or a soil. In some embodiments, the carrier can be added to the plant, plant part or soil without having an adverse effect on plant growth or soil fitness.

As used herein, “cell-free supernatant” or “CFS” refers to the cell-free supernatant of a microbial culture comprising one or more species of microorganisms. In some embodiments, the genera of the one or more microorganisms are selected from the list consisting of Aspergillus spp., Bacillus spp., Rhodopseudomonas spp., Candida spp., Lactobacillus spp., Lactococcus spp., Pseudomonas spp., Saccharomyces spp., or Streptococcus spp.

“Bioprotection” agents are microbes or microbially derived agents that have efficacy in preventing, suppressing, delaying, reducing, or treating pathogenic infection. In some embodiments, a bioprotection agent herein is microalgae. In some embodiments, a bioprotection agent herein is a digested microalgae solution or whole-cell microalgae powder. In some embodiments, a bioprotection agent herein is a CFS of a microbial culture. In some embodiments, a bioprotection agent herein is a plant-beneficial microorganism, such as a bacterium or fungus. In some embodiments, a bioprotection agent does not have a direct anti-pathogenic effect. In some embodiments, a bioprotection agent increases the host plant response against pathogenic infection.

### Bioprotection Compositions Comprising Microalgae

The present disclosure relates to bioprotection compositions comprising microalgae. In some embodiments, the compositions comprise dried whole cell or digested microalgae. In some embodiments, the compositions comprise a cell-free supernatant obtained from the culture of a microbial consortia. In some embodiments, the compositions comprise mycorrhizae, e.g., predominantly endomycorrhizae. In some embodiments, the compositions are granules, powders, or liquid formulations. The present compositions are based, in part, on the surprising result that microalgae compositions improve plant protection from pathogens, e.g., fungal agents, without exhibiting direct fungicidal activity. Without being bound to a particular theory, the present compositions are believed to suppress and/or delay pathogenic infection by improving host plant immunity. In some embodiments, the present compositions are able to upregulate genes involved in Systemic Acquired Resistance (“SAR”).

### Microalgae

Within the present compositions, microalgae are eukaryotic microbial organisms that contain a chloroplast or other plastid, and optionally, are capable of performing photosynthesis, and prokaryotic microbial organisms capable of performing photosynthesis. Microalgae may exist individually, or in chains or groups and can range in size from a few micrometers to a few hundred micrometers. Microalgae do not have roots, stems, or leaves. Microalgae capable of performing photosynthesis are important for life on earth; they produce approximately half of the atmospheric oxygen and use simultaneously the greenhouse gas carbon dioxide to grow photoautotrophically. Microalgae, together with bacteria, form the base of the food web and provide energy for all the trophic levels above them. Microalgae biomass is often measured with chlorophyll a concentrations and can provide a useful index of potential production. Microalgae include obligate photoautotrophs, which cannot metabolize a fixed carbon source as energy, as well as heterotrophs, which can live solely off of a fixed carbon source.

The compositions of the present disclosure comprise microalgae. In some embodiments, the compositions comprise microalgae of a phylum selected from the list consisting of: Cyanobacteria, Chlorophyta, Rhodophyta, Bacillariophyta, Cryptophyta, Dinophyta, Euglenozoa, Haptophyta, Ochrophyta, Cyanophyta, Euglenophyta, Heterokontophyta, and Rhodophyta. In some embodiments, the microalgae included in compositions of the present disclosure are selected from the phyla Chlorophyta, Cryptophyta, Cyanophyta, Euglenophyta, Heterokontophyta, and Rhodophyta.

In some embodiments, the microalgae are of a genus selected from the list consisting of: Anabaena, Aphanizomenon, Arthrospira, Auxenochlorella, Botryococcus, Carteria, Chaetoceros, Chlamydomonas, Chlorella, Chlorococcum, Chroomonas, Coccomyxa, Crypthecodinium, Cryptomonas, Cyclotella, Desmodesmus, Dicrateria, Dunaliella, Euglena, Haematococcus, Isochrysis, Microcystis, Micromonas, Monochrysis, Muriellopsis, Nannochloropsis, Navicula, Neochloris, Nitzschia, Nostoc, Olisthodiscus, Phaeodactylum, Pseudoisochrysis, Pyramimonas, Rhodomonas, Scenedesmus, Schizochytrium, Skeletonema, Spirulina, Synechococcus, Tetraselmis, Thalassiosira, Tisochrysis, and Tolypothrix. In some embodiments, the microalgae of the present disclosure are selected from the genera Chlorella, Scenedesmus, Nannochloropsis, Muriellopsis, Isochrysis, Tisochrysis, Desmodesmus, Haematococcus, Arthrospira, and Anabaena. In some embodiments, the compositions of the present disclosure comprise microalgae of a single genus or species. In some embodiments, the compositions of the present disclosure comprise microalgae of a consortia of microalgae genera or species.

Methods for culturing microalgae are known in the art. In some embodiments, the microalgae are grown according to conventional means for culturing microalgae. In some embodiments, initial microalgae strains and inoculum are generated and maintained in small volumes. Microalgae strains and cells intended for inclusion in the compositions can be selected based on the desired nutrient profile. In some embodiments, microalgae are grown through intensive and controlled culture of microalgae using photobioreactors. Photobioreactors allow the passage of light so that photosynthesis can occur while microalgae grow in optimized culture media. Any form of photobioreactor can be used to grow the microalgae of the present disclosure, include flat panel and tubular photobioreactors. Raceways may also be used for culturing microalgae. During microalgae growth, parameters such as pH, temperature, nutrients, dissolved oxygen and carbon dioxide injection can be maintained in order to ensure maximum production rates.

In some embodiments, microalgae are grown until biomass reaches 0.5-5.0 g/L. Microalgae are then harvested. In some embodiments, microalgae biomass is separated from the liquid culture, e.g., by centrifugation, settling, and/or filtration. Following separation of the biomass, the microalgae biomass is processed, in some embodiments, to ensure that microalgae are not living and/or to make available nutrients from within the microalgal cells. For example, in some embodiments, the biomass is dried. In some embodiments, the biomass is baked, dehydrated, dessicated, freeze-dried, and/or exposed to evaporative drying. In some embodiments, the microalgae is ground after drying to achieve a smaller particle size. In some embodiments, the dried microalgae is ground to a size of 1-10,000 microns. In some embodiments, the dried microalgae is ground to a size of 100-1,000 microns. A dried, ground composition of microalgae cells is referred to herein as “whole cell microalgae powder.” In some embodiments, a composition herein comprises 0.1-50 g/L of whole cell microalgae powder. In some embodiments, a composition herein comprises 0.8-20 g/L of whole cell microalgae powder.

In some embodiments, after separation of the biomass of the microalgae cells from the liquid solution, the microalgae is further processed to degrade cell walls and release nutrients, producing a digested microalgae solution or “DMS” of the present disclosure. Microalgae cells can be degraded by physical, mechanical, chemical, enzymatic, or biological means. In some embodiments, microalgae cells are physically disrupted, e.g., using high pressure and/or mechanical lysis. In some embodiments, microalgae cells are chemically disrupted, e.g., using acids. In some embodiments, microalgae cells are biologically disrupted, e.g., using enzymatic processes including proteolysis.

In some embodiments, the DMS has a nutrient profile as shown in FIG. 1A. In some embodiments, humidity, e.g., water content, of DMS is about 75-95% w/w. In some embodiments, humidity is about 90% w/w. In some embodiments, dry matter is about 5-25% w/w. In some embodiments, dry matter is about 10% w/w. In some embodiments, the content of organic matter is about 5-20% w/w. In some embodiments, the content of organic matter is about 10% w/w. In some embodiments, the carbon content is about 1-15% w/w. In some embodiments, the carbon content is about 5% w/w. In some embodiments, the total nitrogen content of DMS is about 0.1-3.0% w/w. In some embodiments, the total nitrogen content of DMS is about 1-1.5% w/w. In some embodiments, the phosphorous content of DMS is about 0.05-0.5% w/w. In some embodiments, the phosphorous content of DMS is about 0.1% w/w. In some embodiments, the P₂O₅ content of DMS is about 0.05-0.5% w/w. In some embodiments, the P₂O₅ content of DMS is about 0.2% w/w. In some embodiments, the potassium content of DMS is about 0.1-1.0% w/w. In some embodiments, the potassium content of DMS is about 0.4% w/w. In some embodiments, the K₂O content of DMS is about 0.1-1.0% w/w. In some embodiments, the K₂O content of DMS is about 0.5% w/w. In some embodiments, the total nitrogen, phosphorous, and potassium (“NPK”) content including the weight of P₂O₅ and K₂O is about 0.5-5.0% w/w. In some embodiments, the total NPK content including the weight of P₂O₅ and K₂O is about 1.8% w/w. In some embodiments, the total amino acid content of DMS is about 1-15% w/w. In some embodiments, the total amino acid content of DMS is about 5% w/w. In some embodiments, the free amino acid content of DMS is 0.1-10% w/w. In some embodiments, the free amino acid content of DMS is about 2% w/w. In some embodiments, the density of DMS is about 1-1.1 g/mL. In some embodiments, the density of DMS is similar to that of water, i.e., around 1 g/mL. In some embodiments, the pH of DMS is acidic or is adjusted to be acidic. In some embodiments, the pH of DMS is or is adjusted to be about pH 3.5-pH 4.5. In some embodiments, the pH of DMS is adjusted to be around pH 6.0-6.5 or to match the pH of a carrier composition.

In some embodiments, the whole cell microalgae powder comprises the same amounts and/or ratios of components as DMS but with significantly less water content. In some embodiments, the whole-cell microalgae powder comprises less than 10% humidity by weight. In some embodiments, the whole-cell microalgae powder comprises less than 5% humidity by weight. In some embodiments, the whole-cell microalgae powder comprises 1-3% w/w humidity.

In some embodiments, the microalgae components of the present compositions comprise proteins, peptides, amino acids, plant hormones, phytohormones, carbohydrates, fatty acids, vitamins, minerals, polysaccharides, carotenoids, pigments, fibers, and other natural nutrients.

In some embodiments, the compositions disclosed herein differ from macroalgae and other biostimulant products in that the disclosed microalgae-derived compositions comprise a richer and more balanced biochemical composition. In some embodiments, the microalgae components of the present compositions provide all the essential free amino acids. In some embodiments, the microalgae components provide micronutrients, macronutrients, polyunsaturated fatty acids, antioxidants, carotenoids, and vitamins, as well as a high content and wide range of phytohormones. In some embodiments, the microalgae components help maintain the organic carbon in the soil and improve nutrient uptake. In some embodiments, the microalgae components provide a complete nutritional package to growing plants and help fight against abiotic stresses, improving the quality of the produce and the marketable yield.

In some embodiments, a composition of the disclosure, e.g., a granule composition, comprises 0.1%-10.0% w/w DMS. In some embodiments, a composition of the disclosure comprises 0.5%-5.0% w/w DMS.

In some embodiments, a composition of the disclosure, e.g., a liquid composition, comprises 10-100% w/w DMS. In some embodiments, a liquid composition comprising DMS is diluted to 0.3%-0.5% v/v in water prior to application.

In some embodiments, in terms of dry matter of microalgae, a composition comprises 0.01%-20% dry matter of microalgae. In some embodiments, in terms of dry matter of microalgae, a composition comprises 0.5%-5% dry matter of microalgae. In some embodiments, in terms of dry matter of microalgae, a composition comprises 0.05%-0.5% dry matter of microalgae. In some embodiments, in terms of dry matter of microalgae, a composition comprises 0.03%-0.05% dry matter of microalgae.

In some embodiments, a composition of the disclosure, e.g., a seed coating, comprises 5-95% w/w whole-cell microalgae powder. In some embodiments, a composition of the disclosure comprises 10-90% w/w whole-cell microalgae powder. In some embodiments, a composition of the disclosure comprises 20-80% w/w whole-cell microalgae powder.

In some embodiments, a composition of the disclosure, e.g., a liquid formulation, comprises 0.1-40 g/L whole-cell microalgae powder. In some embodiments, a composition of the disclosure, e.g., a liquid formulation, comprises 0.8-20 g/L whole-cell microalgae powder.

### Cell-Free Supernatant

In one aspect, the present disclosure provides compositions comprising microalgae and a cell-free supernatant (“CFS”) of a microbial culture. In some embodiments, the microbial culture comprises a mixture of microorganisms, which may comprise one or more of bacteria, fungi, algae, and/or microorganisms.

In some embodiments, the compositions comprise the CFS of a microbial culture inoculated with an isolated microorganism, wherein the microorganism comprises one or more of Aspergillus spp., Bacillus spp., Rhodopseudomonas spp., Candida spp., Lactobacillus spp., Lactococcus spp., Pseudomonas spp., Saccharomyces spp., or Streptococcus spp.; or combinations thereof.

In some embodiments, a composition of the disclosure comprises the CFS of a microbial culture inoculated with a mixed culture, IN-M1, ATCC Patent Deposit Designation No. PTA-12383. In some embodiments, the composition comprises the CFS of a microbial culture inoculated with a mixed culture, IN-M2, deposited with the ATCC Patent Depository under the Budapest Treaty, on Sep. 4, 2014, with the designation IN-M2, under Account No. 200139, with the ATCC Patent Deposit Designation No. PTA-121556. In some embodiments, the CFS is filter-sterilized.

In some embodiments, the CFS is from a microbial culture comprising Aspergillus spp., wherein the species is Aspergillus oryzae, or wherein the Aspergillus spp. is Aspergillus oryzae, IN-AO1, deposited with the ATCC Patent Depository under the Budapest Treaty, on Sep. 4, 2014, with the designation IN-AO1, under Account No. 200139, with the ATCC Patent Deposit Designation No. PTA-121551. In some embodiments, the microbial culture comprises Bacillus subtilis or Bacillus subtilis, IN-BS1, ATCC Patent Deposit Designation No. PTA-12385. In some embodiments, the culture comprises Rhodopseudomonas palustris, or Rhodopseudomonas palustris, IN-RP1, Accession No, PTA-12387. In some embodiments, the culture comprises Candida utilis or Candida utilis, IN-CU1, deposited with the ATCC Patent Depository under the Budapest Treaty, on Sep. 4, 2014, with the designation IN-CU1, under Account No. 200139, with the ATCC Patent Deposit Designation No. PTA-121550. In some embodiments, the culture comprises Lactobacillus casei, Lactobacillus helveticus, Lactobacillus lactis, Lactobacillus rhamnosus, or Lactobacillus plantarum, or combinations thereof. In some embodiments, the culture comprises Lactobacillus helveticus, IN-LH1, ATCC Patent Deposit Designation No. PTA-12386. In some embodiments, the culture comprises Lactobacillus casei, referred to herein as IN-LC1, which was deposited with the ATCC Patent Depository under the Budapest Treaty, with the designation IN-LC1, on Sep. 4, 2014, under Account No. 200139, with the ATCC Patent Deposit Designation No. PTA-121549. In some embodiments, the culture comprises Lactobacillus lactis, IN-LL1, which was deposited with the ATCC Patent Depository under the Budapest Treaty, with the designation IN-LL1, on Sep. 4, 2014, under Account No. 200139, with the ATCC Patent Deposit Designation No. PTA-121552. In some embodiments, the culture comprises Lactobacillus plantarum, IN-LP1, deposited with the ATCC Patent Depository under the Budapest Treaty, on Sep. 4, 2014, with the designation IN-LP1, under Account No. 200139, with the ATCC Patent Deposit Designation No. PTA-121555. In some embodiments, the culture comprises Lactobacillus rhamnosus, IN-LR1, deposited with the ATCC Patent Depository under the Budapest Treaty, on Sep. 4, 2014, with the designation IN-LR1, under Account No. 200139, with the ATCC Patent Deposit Designation No. PTA-121554. In some embodiments, the culture comprises Pseudomonas aeruginosa. In some embodiments, the culture comprises Rhodopseudomonas palustris. In some embodiments, the culture comprises Rhodopseudomonas palustris, IN-RP1, ATCC Patent Deposit Designation No. PTA-12383. In some embodiments, the culture comprises Rhodopseudomonas palustris, IN-RP2, deposited with the ATCC Patent Depository under the Budapest Treaty, on Sep. 4, 2014, with the designation IN-RP2, under Account No. 200139, with the ATCC Patent Deposit Designation No. PTA-121553. In some embodiments, the culture comprises Saccharomyces cerevisiae. In some embodiments, the culture comprises Saccharomyces cerevisiae, IN-SC1, ATCC Patent Deposit Designation No. PTA-12384. In some embodiments, the culture comprises Streptococcus lactis. In some embodiments, the culture comprises at least two of Aspergillus spp., Bacillus spp., Rhodopseudomonas spp., Candida spp., Lactobacillus spp., Pseudomonas spp., Saccharomyces spp., or Streptococcus spp. In some embodiments, the culture comprises Aspergillus oryzae, Bacillus subtilis, Lactobacillus helveticus, Lactobacillus casei, Rhodopseudomonas palustris, and Saccharomyces cerevisiae.

CFS compositions of the present disclosure are CFSs of microbial cultures inoculated with one or more isolated microorganisms. Examples of these microorganisms include, but are not limited to, Aspergillus spp., Bacillus spp., Rhodopseudomonas spp., Candida spp., Lactobacillus spp., Lactococcus spp., Pseudomonas spp., Saccharomyces spp., and Streptococcus spp. Microbial cultures disclosed herein may comprise differing amounts and combinations of these and other microorganisms depending on the methods being performed by particular cell-free supernatant compositions.

In various aspects, the microorganisms cultured to produce the cell-free supernatant compositions of the present disclosure can be grown in large, industrial scale quantities. For example, and not to be limiting, a method for growing microorganisms in 1000 liter batches comprises media comprising 50 liters of non-sulphur agricultural molasses, 3.75 liters wheat bran, 3.75 liters kelp, 3.75 liters bentonite clay, 1.25 liters fish emulsion, 1.25 liters soy flour, 675 mg commercially available sea salt, 50 liters of selected strains of microorganisms, up to 1000 liters non-chlorinated warm water to form a microbial culture. A method for growing the microorganisms can further comprise dissolving molasses in some of the warm water, adding the other ingredients listed above to the fill tank, keeping the temperature at 30° C., and, after the pH drops to about 3.7 within 5 days, stirring lightly once per day and monitoring pH, forming a microbial culture. The microbial culture can incubate for 2-8 weeks. After the time period determined for incubation, the microorganisms are separated from the liquid portion of the microbial culture, and the cell-free liquid remaining is a cell-free supernatant composition of the present disclosure. A cell-free supernatant composition may be bottled and stored, for example, in airtight containers, or out of sunlight, for example, at room temperature. Microbial cultures can be made as taught in U.S. patent application Ser. No. 13/979,419, which is herein incorporated by reference in its entirety.

In some embodiments, a microbial culture comprises an Aspergillus spp. such as Aspergillus oryzae. In some embodiments, the Aspergillus spp. is Aspergillus oryzae, referred to herein as IN-AO1, which was deposited with the ATCC Patent Depository under the Budapest Treaty, with the designation IN-AO1, on Sep. 4, 2014, under Account No. 200139, with the ATCC Patent Deposit Designation No. PTA-121551.

In some embodiments, a microbial culture comprises a Bacillus spp. such as Bacillus subtilis. In some embodiments, the Bacillus spp. is Bacillus subtilis, referred to herein as IN-BS1, which was deposited with the ATCC under the Budapest Treaty, on Jan. 12, 2011, under Account No. 200139, and given ATCC Patent Deposit Designation No. PTA12385.

In some embodiments, a microbial culture comprises a Rhodopseudomonas spp. such as Rhodopseudomonas palustris. In some embodiments, the Rhodopseudomonas spp. is Rhodopseudomonas palustris, referred to herein as IN-RP1, which was deposited with the ATCC under the Budapest Treaty, on Jan. 12, 2011, under Account No. 200139, and given ATCC Patent Deposit Designation No. PTA-12387.

In some embodiments, a microbial culture comprises a Candida spp. such as Candida utilis. In some embodiments, the Candida spp. is Candida utilis, referred to herein as IN-CU1, which was deposited with the ATCC Patent Depository under the Budapest Treaty, with the designation IN-CU1, on Sep. 4, 2014, under Account No. 200139, with the ATCC Patent Deposit Designation No. PTA-121550.

In some embodiments, a microbial culture comprises a Lactobacillus spp. such as Lactobacillus helveticus, Lactobacillus casei, Lactobaccillus rhamnosus, or Lactobacillus plantarum, or combinations thereof. In some embodiments, the Lactobacillus spp. is Lactobacillus helveticus. In some embodiments, the Lactobacillus spp. is Lactobacillus helveticus, referred to herein as IN-LH1, which was deposited with the ATCC under the Budapest Treaty, on Jan. 12, 2011, under Account No. 200139, and given ATCC Patent Deposit Designation No. PTA-12386. In some embodiments, a microbial culture comprises a Lactobacillus spp. such as Lactobacillus plantarum. In some embodiments, the Lactobacillus spp. is Lactobacillus plantarum, referred to herein as IN-LP1, which was deposited with the ATCC Patent Depository under the Budapest Treaty, on Sep. 4, 2014, with the designation IN-LP1, under Account No. 200139, with the ATCC Patent Deposit Designation No. PTA-121555. In some embodiments, a microbial culture comprises an Lactobacillus spp. such as Lactobacillus rhamnosus. In some embodiments, the Lactobacillus spp. is Lactobacillus rhamnosus, referred to herein as IN-LR1, which was deposited with the ATCC Patent Depository under the Budapest Treaty, with the designation IN-LR1, on Sep. 4, 2014, under Account No. 200139, with the ATCC Patent Deposit Designation No. PTA-121554. In some embodiments, a microbial culture comprises an Lactobacillus spp. such as Lactobacillus lactis. In some embodiments, the Lactobacillus spp. is Lactobacillus lactis, referred to herein as IN-LL1, which was deposited with the ATCC Patent Depository under the Budapest Treaty, with the designation IN-LL1, on Sep. 4, 2014, under Account No. 200139, with the ATCC Patent Deposit Designation No. PTA-121552. In some embodiments, a microbial culture comprises a Lactobacillus spp. such as Lactobacillus casei. In some embodiments, the Lactobacillus spp. is Lactobacillus casei, referred to herein as IN-LC1, which was deposited with the ATCC Patent Depository under the Budapest Treaty, with the designation IN-LC1, on Sep. 4, 2014, under Account No. 200139, with the ATCC Patent Deposit Designation No. PTA-121549.

In some embodiments, a microbial culture comprises a Pseudomonas spp. such as Pseudomonas aeruginosa. In some embodiments, the Pseudomonas spp. is Pseudomonas aeruginosa.

In some embodiments, a microbial culture comprises a Rhodopseudomonas spp. such as Rhodopseudomonas palustris. In some embodiments, the Rhodopseudomonas spp. is Rhodopseudomonas palustris, referred to herein as IN-RP1, which was deposited with the ATCC under the Budapest Treaty, on Jan. 12, 2011, under Account No. 200139, and given ATCC Patent Deposit Designation No. PTA-12383. In some embodiments, a microbial culture comprises a Rhodopseudomonas spp. such as Rhodopseudomonas palustris, referred to herein as IN-RP2, which was deposited with the ATCC Patent Depository under the Budapest Treaty, on Sep. 4, 2014, with the designation IN-RP2, under Account No. 200139, with the ATCC Patent Deposit Designation No. PTA-121553.

In some embodiments, a microbial culture comprises a Saccharomyces spp. such as Saccharomyces cerevisiae. In some embodiments, the Saccharomyces spp. is Saccharomyces cerevisiae, referred to herein as IN-SC1, which was deposited with the ATCC under the Budapest Treaty, on Jan. 12, 2011, under Account No. 200139, and given ATCC Patent Deposit Designation No. PTA-12384. In some embodiments, a microbial culture comprises a Saccharomyces spp. such as Saccharomyces lactis.

A microbial culture may comprise a mixture of isolated microorganisms comprising Aspergillus oryzae, referred to herein as IN-AO1 (ATCC Patent Deposit Designation No. PTA-121551), Bacillus subtilis, referred to herein as IN-BS1 (ATCC Patent Deposit Designation No. PTA-12385), Rhodopseudomonas palustris, referred to herein as IN-RP1 (ATCC Patent Deposit Designation No. PTA-12387), Candida utilis, referred to herein as IN-CU1 (ATCC Patent Deposit Designation No. PTA-121550), Lactobacillus casei, referred to herein as IN-LC1 (ATCC Patent Deposit Designation No. PTA-121549), Lactobacillus helveticus, referred to herein as IN-LH1 (ATCC Patent Deposit Designation No. PTA-12386), Lactobacillus rhamnosus, referred to herein as IN-LR1 (ATCC Patent Deposit Designation No. PTA-121554), Lactobacillus plantarum, referred to herein as IN-LP1 (ATCC Patent Deposit Designation No. PTA-121555), Pseudomonas aeruginosa. Rhodopseudomonas palustris, referred to herein as IN-RP1 (ATCC Patent Deposit Designation No. PTA-12387), Rhodopseudomonas palustris, referred to herein as IN-RP2 (ATCC Patent Deposit Designation No. PTA-121553), Saccharomyces cerevisiae, referred to herein as IN-SC1 (ATCC Patent Deposit Designation No. PTA-12384), and Saccharomyces lactis. Examples of isolated microorganisms inoculated in microbial cultures of the present disclosure include, but are not limited to, Aspergillus oryzae, Rhodopseudomonas palustris, Candida utilis, Lactobacillus helveticus, Lactobacillus casei, Lactobacillus rhamnosus, Lactobacillus plantarum, Pseudomonas aeruginosa, Rhodopseudomonas palustris, Saccharomyces cerevisiae, and Saccharomyces lactis.

Microbial cultures may comprise differing amounts and combinations of these and other isolated microorganisms. Thus, in various aspects, a microbial culture is inoculated with of at least two of the following: Aspergillus spp., Bacillus spp., Rhodopseudomonas spp., Candida spp., Lactobacillus spp., Pseudomonas spp., Saccharomyces spp., or Streptococcus spp. In some embodiments, a microbial culture is inoculated with Aspergillus oryzae, Bacillus subtilis, Lactobacillus helveticus, Lactobacillus casei, Rhodopseudomonas palustris, and Saccharomyces cerevisiae. In some embodiments, a microbial culture is inoculated with a mixed culture, IN-M1 (ATCC Patent Deposit Designation No. PTA-12383). The deposited mixed culture, IN-M1, consists of the strains IN-LH1, IN-BS1, IN-SC1, IN-RP1; and Lactobacillus casei and Aspergillus oryzae, using the designations used hereinbefore. In some embodiments, a microbial culture is inoculated with Aspergillus oryzae, Bacillus subtilis, Candida utilis, Lactobacillus casei, Lactobacillus helveticus, Lactobacillus plantarum, Lactobacillus rhamnosus Lactococcus lactis, Rhodopseudomonas palustris, and Saccharomyces cerevisiae. In some embodiments, a microbial culture is inoculated with and comprises a mixed culture, referred to herein as IN-M2, which was deposited with the ATCC Patent Depository under the Budapest Treaty, on Sep. 4, 2014, with the designation IN-M2, under Account No. 200139, with the ATCC Patent Deposit Designation No. PTA-121556. The deposited mixed culture, IN-M2, consists of the strains IN-LC1, IN-LH1, IN-LP1, IN-LR1, IN-LL1, IN-BS1, IN-AO1, IN-SC1, IN-CU1, IN-RP1, and IN-RP2, using the designations used hereinbefore. Any of the disclosed microbial cultures can be the microbial culture source for a cell-free supernatant composition of the present disclosure. Cell-free supernatant compositions of the present disclosure are useful in the methods taught herein.

In some embodiments, a cell-free supernatant is diluted in water. In some embodiments, a cell-free supernatant is diluted in water from a stock concentration of cell-free supernatant to about 1/10, 1/20, 1/30, 1/40, 1/50, 1/60, 1/70, 1/80, 1/90, 1/100, 1/150, 1/200, 1/500, 1/1000, or 1/2000 in water.

Also disclosed are methods for preparing a cell-free supernatant composition comprising the steps of: (a) inoculating a fermentation broth with one or more isolated microorganisms, wherein the microorganisms comprises Aspergillus spp., Bacillus spp., Rhodopseudomonas spp., Candida spp., Lactobacillus spp., Pseudomonas spp., Saccharomyces spp., or Streptococcus spp.; or combinations thereof; (b) incubating the inoculated fermentation broth for at least five hours; and (c) centrifuging the culture after step (b) for at least 10 minutes at a centrifugal force of 10,000×g; thereby providing the cell-free supernatant.

Microbial consortia such as IN-M1 deposited with ATCC Patent Deposit No. PTA-12383 or IN-M2 deposited with ATCC Deposit No. PTA-121556 can be cultured as described in U.S. Pat. Nos. 10,588,320 and 10,561,149, incorporated by reference herein in their entireties.

As detailed in U.S. Patent Publication No. 2018/0255786, the CFS of the present disclosure can protect plants from damage due to plant pathogens.

In some embodiments, the CFS has about 95-99% w/w water content. In some embodiments, the CFS has about 98% w/w water content. In some embodiments, the CFS has about 1-5% w/w dry matter. In some embodiments, the CFS has about 2% w/w dry matter. In some embodiments, the CFS has a density around that of water, e.g., around 1 g/mL. In some embodiments, the pH of the CFS is between 7 and 8. In some embodiments, the pH of the CFS is about 7.5. In some embodiments, the organic matter content is about 0.5-3.0% w/w. In some embodiments, the organic matter content is about 1.0-2.0% w/w. In some embodiments, the organic carbon content is about 0.1-2.0% w/w. In some embodiments, the organic carbon content is about 1% w/w. In some embodiments, the total nitrogen content is about 0.05-0.5% w/w. In some embodiments, the total nitrogen content is about 0.25% w/w. In some embodiments, the CFS does not have a significant concentration of amino acids.

### Mycorrhizae

A mycorrhiza is a symbiotic association between a fungus and the roots of a vascular plant. As used herein, the terms mycorrhiza and mycorrhizae are also used to refer to the mycorrhizal fungi. This type of association is found in 85% of all plant families in the wild, including many crop species such as grains. In the association between mycorrhizae and plant roots, the fungus colonizes the host plant's roots, either intracellularly or extracellularly. The functional symbiosis provides a suitable and sufficient carbohydrate source for the fungal symbiont. The plant symbiont benefits can be numerous and include improved nutrient and water uptake, additional carbon acquisition, increased sink strength for photosynthate translocation, increased production of phytohormones, improved resistance to pathogens, and heavy metal tolerance. Mycorrhizae are critically important organs for resource uptake by most terrestrial plants. In the absence of an appropriate fungal symbiont, many terrestrial plants suffer from resource limitations and ultimately reduced growth, and poor fitness. Mycorrhizae protect plants from adverse conditions, such as lack of water and nutrients.

Mycorrhizal fungi are commonly divided into “ectomycorrhiza” (the hypha of fungi do not penetrate individual cells with in the root) and “endomycorrhiza” (the hypha of fungi penetrate the cell wall and invaginate the cell membrane). In the case of endomycorrhizae, fungal hyphae grow into the intercellular wall spaces of the cortex and penetrate individual cortical cells. As they extend into the cell, they do not break the plasma membrane or the tonoplast of the host cell. Instead, the hypha is surrounded by these membranes and forms structures known as arbuscules, which participate in nutrient ion exchange between the host plant and the fungus. (Mauseth, 1988). Calculations show that a root associated with mycorrhizal fungi can transport phosphate at a rate more than four times higher than that of a root not associated with mycorrhizae (Nye and Tinker, 1977).

Endomycorrhizae are variable and are further classified as arbuscular, ericoid, arbutoid, monotropoid and orchid mycorhizae. Arbuscular mycorrhizal fungi (“AMF”) are ubiquitous in soil habitats and form beneficial symbiosis with the roots of angiosperms and other plants. AMF are typically associated with the roots of herbaceous plants, but may also be associated with woody plants. AMF are an example of a mycorrhiza that involves entry of the hyphae into the plant root cell walls to produce structures that are either balloon-like (vesicles) or dichotomously-branching invaginations (arbuscules). The fungal hyphae do not in fact penetrate the protoplast (i.e., the interior of the cell), but invaginate the cell membrane. The structure of the arbuscules greatly increases the contact surface area between the hypha and the cell cytoplasm to facilitate the transfer of nutrients between them.

Of the symbiotic associations of plant and fungi, those involving an association between plants and Glomeromycota fungi has the widest distribution in the nature. Arbuscular mycorrhiza fungi inhabit a variety of ecosystems including agricultural lands, forests, grasslands and many stressed environments, and these fungi colonize the roots of most plants, including bryophytes, pteridophytes, gymnosperms and angiosperms. Arbuscular mycorrhizal fungi belong to the family Endogonaceae, of the order Muccorales, of the class Zygomycetes. The arbuscular mycorrhizal forming genera of the family includes Acaulospora, Entrophospora, Gigaspora, Glomus, Sclerocystis and Scutellospora.

In some embodiments, the compositions of the present disclosure comprise both ectomycorrhizae and endomycorrhizae. In some embodiments, the compositions of the present disclosure comprise predominantly endomycorrhizae. In some embodiments, the compositions of the present disclosure comprise more than 50%, 60%, 70%, 80%, or 90% endomycorrhizae as a percentage of overall mycorrhizae content. In some embodiments, the compositions of the present disclosure comprise more than 95% endomycorrhizae as a percentage of overall mycorrhizae content. In some embodiments, only endomycorrhiza are used in the coating mixture, while in some embodiments, a combination of ectomycorrhiza and endomycorrhiza is used. In some embodiments, a mycorrhiza mixture is used in which the mixture contains at least 95 percent, or at least 97 percent endomycorrhiza content and the balance to achieve 100 percent is comprised of ectomycorrhiza content.

In some embodiments, the present compositions comprise arbuscular, ericoid, arbutoid, monotropoid, or orchid mycorrhizae. In some embodiments, the compositions comprise arbuscular mycorrhizal fungi. In some embodiments, the compositions comprise Glomeromycota fungi. In some embodiments, the compositions comprise mycorrhizae of the genus Acaulospora, Entrophospora, Gigaspora, Glomus, Rhizophagus, Sclerocystis or Scutellospora. In some embodiments, the endomycorrhiza content comprises any one of the following species of endomycorrhizal fungi: Rhizophagus Sp., Glomus Sp., Acaulospora Sp., Scutellospora Sp. and Glomus Sp. In some embodiments, the endomycorrhiza content comprises a mixture of the foregoing endomycorrhizal fungi.

In some embodiments, combinations of the foregoing endomycorrhiza are created to produce desired results in plant growth. Rhizophagus Sp. are able to penetrate the cells of the root to form tree-like structures (arbuscular) for the exchange of sugars and nutrients with the host plant and are highly efficient in nutrient-deficient soil. Glomus Sp. obtain carbon from the host plant in exchange for nutrients and other benefits, and help in soil detoxification processes (for example, detoxifying arsenic-laced soils). Examples of Glomus species include Glomus aggregatum, Glomus brasilianum, Glomus clarum, Glomus deserticola, Glomus etunicatum, Glomus fasciculatum, Glomus intraradices, Glomus monosporum, and Glomus mosseae. They also improve soil nodulation and nutrient uptake to the plant, increase the surface area for absorption of water, phosphorus, amino acids, and nitrogen, and are more resistant to certain soil-borne diseases. Acaulospora Sp. are able to interact with and change the environment in the favor of the host plants, improving soil structure and quality. Scutellospora Sp. create humic compounds, polysaccharides, and glycoproteins that bind soils, increase soil porosity, and promote aeration and water movement into the soil. Alternatively, yet other versions of endomycorrhizal fungi may be used.

Ectomycorrhizae typically form between the roots of woody plants and fungi belonging to the divisions Basidiomycota, Ascomycota, or Zygomycota. These are external mycorrhizas that form a cover on root surfaces and between the root's cortical cells. Besides the mantle formed by the mycorrhizae, most of the biomass of the fungus is found branching into the soil, with some extending to the apoplast, stopping short of the endodermis. Ectomycorrhizae are found in 10% of plant families, mostly woody species, including the oak, pine, eucalyptus, dipterocarp, and olive families. In some embodiments, the composition comprises ectomycorrhizae. In some embodiments, the ectomycorrhizae are of the phylum Basidiomycota. In some embodiments, the ectomycorrhizae comprise a strain of Laccaria bicolor, Laccaria laccata, Pisolithus tinctorius, Rhizopogon amylopogon, Rhizopogon fulvigleba, Rhizopogon luteolus, Rhizopogon villosuli, Scleroderma cepa, or Scleroderma citrinum. In some embodiments, the ectomycorrhiza content comprises Pisolithus Sp., or others. Such ectomycorrhiza are efficient in uptake of inorganic and organic nutrient resources, and enhance the capability to utilize organic nitrogen sources efficiently. They further create structures that host nitrogen-fixing bacteria that contribute to the amount of nitrogen taken up by plants in nutrient-poor environments. They are also highly nickel-tolerant, and work efficiently in ultramafic soil.

In some embodiments, the mycorrhizae are ericoid mycorrhizae. In some embodiments, the mycorrhizae are of the phylum Ascomycota, such as Hymenoscyphous ericae or Oidiodendron sp. In some embodiments, the mycorrhiza are arbutoid mycorrhizae. In some embodiments, the mycorrhizae are of the phylum Basidiomycota. In some embodiments, the mycorrhizae are monotripoid mycorrhizae. In some embodiments, the mycorrhizae are of the phylum Basidiomycota. In some embodiments, the mycorrhizae are orchid mycorrhiza. In some embodiments, the mycorrhizae are of the genus Rhizoctonia.

The active component of the mycorrhiza may be the spores, hyphae, extramatrix arbuscular mycelium, glomalin and rootlets, colonized by the fungus in question.

In some embodiments, the compositions of the present disclosure comprise a commercially available mycorrhizae powder. In some embodiments, the composition comprises mycorrhizae powder on an inert carrier, such as a sugar, starch, clay-based carrier, mineral-based carrier, or the like.

Mycorrhizal products comprise different elements of mycorrhizae. In some embodiments, products are characterized based on the quantity of infective propagules. Propagules include spores, vesicles, pieces of mycelium, and colonized roots. In some embodiments, the mycorrhizae is quantified in terms of number of spores. In some embodiments, the mycorrhizae has a concentration of 100 to 10,000 infective spores per gram. In some embodiments, the mycorrhizae has a concentration of 300 to 6,000 infective spores per gram. Mycorrhizae may also be quantified based on propagules. In some embodiments, a mycorrhizae composition comprises 50 to 50,000 infectivity propagules per gram. In some embodiments, the mycorrhizae has 80-6,000 infectivity propagules per gram.

In some embodiments, a composition of the disclosure comprises 0.5-5.0% w/w mycorrhizae powder. In some embodiments, a composition of the disclosure comprises about 0.5-500 spores/gram. In some embodiments, a composition of the disclosure comprises about 10-300 spores/gram. In some embodiments, a composition of the disclosure is formulated to comprise 10,000-2,000,000 spores per amount to be distributed to one hectare. For example, in some embodiments where 10 kg of composition are to be distributed per one hectare, the composition comprises 5,000-200,000 spores per kg.

### Diazotrophic Bacteria

The ability of specific bacterial species to promote plant growth has long been recognized. For example, nitrogen-fixing bacteria such as Rhizobium species provide plants with essential nitrogenous compounds. Species of Azotobacter and Azospirillum have also been shown to promote plant growth and increase crop yield, promoting the accumulation of nutrients in plants.

In some embodiments, a composition of the disclosure comprises plant-beneficial bacteria. In some embodiments, the composition comprises nitrogen-fixing, i.e., diazotrophic, bacteria. In some embodiments, the composition comprises symbiotic diazotrophic bacteria. In some embodiments, the composition comprises gram positive or gram negative diazotrophic bacteria.

In some embodiments, a composition of the disclosure comprises a bacterium of the genus Anabaena, Azoarcus, Azorhizobium, Azospirillum, Azotobacter, Bacillus, Bradyrhizobium, Burkholderia, Clostridium, Frankia, Gluconacetobacter, Herbaspirillum, Klebsiella, Mesorhizobium, Nitrosospira, Nostoc, Paenibacillus, Parasponia, Pseudomonas, Rhizobium, Rhodobacter, Sinorhizobium, Spirillum, and Xanthomonus. Additional genera and species of plant beneficial bacteria are known in the art. See, e.g., U.S. Patent Publication Nos. 2014/0256547, 2015/0239789, 2016/0100587, and 2019/0124917, each of which is incorporated by reference herein in its entirety.

In some embodiments, the composition comprises a diazotrophic bacterium of the genus Bacillus, Rhizobium, Bradyrhizobium, or Azospirillum. Examples of species for inclusion in the compositions of the disclosure include: Azospirillum lipoferum, Azospirillum brasilense, Azospirillum amazonense, Azospirillum halopraeferens, Azospirillum irakense, Bacillus itchenmformis, Bacillus megaterium, Bacillus pumilus, Bacillus amyloliquefaciens, Bacillus lichenmformis, Bacillus oleronius, Bacillus megaterium, Bacillus mojavensis, Bacillus pumilus, Bacillus subtilis, Bacillus circulans, Bacillus globisporus, Bacillus firmus, Bacillus thuringiensis, Bacillus cereus, Bradyrhizobium japonicum, Bradyrhizobium elkanii, or Bradyrhizobium diazoefficiens, and Rhizobium meliloti. In some embodiments, the composition comprises Bradyrhizobium japonicum.

In some embodiments, a composition of the present disclosure includes a diazotrophic bacterium, i.e., the bacterium is mixed with the CFS and microalgae and/or mycorrhizae. In some embodiments, a composition of the present disclosure is administered alongside a diazotrophic bacterium, i.e., simultaneously with, shortly after, or shortly before administration of the diazotrophic bacterium.

### Carriers

In some embodiments, the composition comprises a solid substrate or carrier. In some embodiments, carrier granules are prepared as a substrate or carrier for the combined solution. In some embodiments, granules are prepared prior to the mixture of the solution, or simultaneous with or after the solution preparation. In some embodiments, the carrier is a natural clay granule or mineral- or organic-based granule. In some embodiments, the carrier is limestone, silica, talc, kaolin, dolomite, calcium sulfate, calcium carbonate, magnesium sulfate, magnesium carbonate, magnesium oxide, diatomaceous earth, zeolite, bentonite, dolomite, leonardite, attapulgite, trehalose, chitosan, shellac, pozzolan, diatomite, or diatomaceous earth, or any combination thereof. In some embodiments, the carrier is a solid substrate formed as granules or extruded pellets of other materials such as synthetic fertilizer.

In some embodiments, the granules have a diameter of about 1-10 mm. In some embodiments, the granules have a diameter of about 2-4 mm.

Natural clay based granules are inert, biodegradable, resistant to attrition due to mixing, and have a neutral pH. Accordingly, in some embodiments, the acidity of a coating solution is matched to that of the carrier prior to coating. Clay granules are available in several size grades from 12/25 mesh to 10/20 & 16/35 mesh (ASTM). A range of carrier sizes are suitable for use in some embodiments of the disclosure.

In some embodiments, the granules are formed from zeolite. Zeolite is a soil conditioner that can control and raise the pH of the soil and improve soil moisture. Synthetic and natural zeolites are hydrated aluminosilicates with symmetrically stacked alumina and silica tetrahedra which result in an open and stable three-dimensional honeycomb structure with a negative charge. The negative charge within the pores is neutralized by positively charged ions (cations) such as sodium. Their aluminosilicate frameworks allows them to be used as cationic exchangers because of their high cation exchange capacity (CEC) due to the presence of trivalent Al atoms in the zeolite framework which induce negative charges that are compensated by the presence of cations. In some embodiments, the zeolite is a natural zeolite. In some embodiments, the zeolite is a synthetic zeolite. In some embodiments, the zeolite is Clinoptilolite.

In some embodiments, the granules are formed from dolomite. Dolomite can be used for soil neutralization to correct acidity. Adding zeolite or dolomite to manure improves the nitrification process. These materials are commonly used as slow release substances for pesticides, herbicides and fungicides. In some embodiments, zeolite or dolomite particles, or combinations of the two, may be used for the carrier granules.

In some embodiments, attapulgite is used as the carrier granule. Attapulgite is a magnesium aluminum phyllosilicate which occurs in a type of clay soil, and it is used as a processing aid and functions as a natural bleaching clay for the purification of vegetable and animal oils. It is available in both colloidal and non-colloidal forms. In some embodiments, attapulgite particles or granules are used as carrier granules in the present compositions.

Leonardite is an oxidation product of lignite coal, mined from near surface pits. Leonardite is a high quality humic material soil conditioner which acts as a natural chelator. It is typically soft, dark colored, and vitreous, containing high concentrations of the active humic acid and fulvic acid. In some embodiments, leonardite is used, alone or in combination with other materials, as a carrier granule.

Bentonite pellets are used in agriculture for soil improvement, livestock feed additives, pesticide carriers, and other purposes. Bentonite mixed with chemical fertilizer can fix ammonia and can act as a buffer for fertilizers. The inherent characteristics of water retention and absorbency makes it an ideal addition to improve the fertility of soil. The prevalence of sandy soil in many regions that suffer from low water and nutrient holding characteristics, can be significantly enhanced by the addition and blending of calcined bentonite. In some embodiments, bentonite, or calcined bentonite, is used as a carrier granule.

In some embodiments, the carrier granules comprise a mix of different materials such as clay, leonardite, attapulgite, zeolite, and/or bentonite.

In some embodiments, the composition comprises more than 50% w/w solid carrier. In some embodiments, the composition comprises more than 70, 80, 90, or 95% w/w solid carrier. In some embodiments, the composition comprises about 80-95% w/w solid carrier.

In some embodiments, the composition comprises a liquid carrier. Non-limiting examples of liquids useful as carriers for compositions disclosed herein include water, an aqueous solution, or a non-aqueous solution. In some embodiments, a carrier is water. In some embodiments, a carrier is an aqueous solution. In some embodiments, a carrier is a non-aqueous solution. For example, in embodiment involving a soil drench, foliar spray, or other liquid composition, suitable liquid carriers include water, buffered water, and oils.

In some embodiments, the composition comprises more than about 90% w/w liquid carrier. In some embodiments, the composition comprises about 95-99.9% w/w liquid carrier. In some embodiments, the composition comprise about 99.5-99.7% w/w liquid carrier.

### Pesticidal and Pathogenicidal Agents

In some embodiments, the present compositions comprise ingredients to prevent or treat the growth of undesirable organisms near or within the host plant. In some embodiments, the compositions comprise one or more pathogenicidal agents. In some embodiments, the compositions comprise agents for preventing, suppressing, delaying, or treating pathogenic infection. In some embodiments, the compositions comprise an antimicrobial agent, fungicide, pesticide, nematicide, herbicide, insecticide, or molluscicide.

In some embodiments, a composition comprises a fungicide. Exemplary fungicides include, but are not limited to, Mefenoxam & Fludioxonil (ApronMaxx RTA, Syngenta USA), tebuconazole, simeconazole, fluquinconazole, difenoconazole, 4,5-dimethyl-N-(2-propenyl)-2-(trimethylsilyl)-3-thiophenecarboxamide (silthiopham), hexaconazole, etaconazole, propiconazole, triticonazole, flutriafol, epoxiconazole, fenbuconazole, bromuconazole, penconazole, imazalil, tetraconazole, flusilazole, metconazole, diniconazole, myclobutanil, triadimenol, bitertanol, pyremethanil, cyprodinil, tridemorph, fenpropimorph, kresoxim-methyl, azoxystrobin, ZEN90160, fenpiclonil, benalaxyl, furalaxyl, metalaxyl, R-metalaxyl, orfurace, oxadixyl, carboxin, prochloraz, trifulmizole, pyrifenox, acibenzolar-5-methyl, chlorothalonil, cymoaxnil, dimethomorph, famoxadone, quinoxyfen, fenpropidine, spiroxamine, triazoxide, BAS50001 F, hymexazole, pencycuron, fenamidone, guazatine, and cyproconazole.

In some embodiments, a composition comprises a pesticide. Exemplary pesticides include, but are not limited to, any bacterial species (i.e., Bacillus thuringiensis), viruses (i.e., densoviruses), biocontrol pesticides, abamectin, phostoxin/fumitoxin, bifenthrin, carbaryl, chlorfenapyr, beta-cyfluthrin, cypermethrin, deltamethrin, dichlorvos, D-phenothrin, D-trans allethrin, resmethrin, methomyl, hydramethylnon, fenoxycarb, fipronil, imidacloprid, imidacloprid, lambda-cyhalothrin, malathion, methoprene, naled, nithiazine, P-dichlorobenzene, permethrin, permethrin-piperonyl butoxide, propetamphos, propoxur, pyrethrins, phenothrin, allethrin, hydroprene, resmethrin, spinosad, sumthrin, sumthrin-piperonyl butoxide, temephos, mosquito larvicide, pupicide, or any combination thereof.

In some embodiments, a composition herein comprises a) microalgae, e.g., in the form of whole-cell microalgae powder or DMS, to suppress or delay pathogenic infection, e.g., by upregulating host plant immunity; and b) a pathogenicidal, e.g., fungicidal, agent to directly treat or prevent pathogenic infection. In some embodiments, the microalgae component of the composition improves the efficacy of the pathogenicidal agent.

### Additional Ingredients

In some embodiments, the composition comprises ingredients in addition to CFS, microalgae and mycorrhizae components. In some embodiments, the composition comprises an excipient, surfactant, fertilizer, nutrient composition, diluent, binder, disintegrant, inert filler, pH stabilizer, spreader, fixative, defoamer, carrier, antifreeze agent, antioxidant, preservative, or anti-aggregation agent. One of ordinary skill in the art will appreciate that additional agrochemically acceptable excipients are available for inclusion in the present compositions without departing from the scope of the disclosure. Agriculturally acceptable excipients are commercially manufactured and available through a variety of companies.

In some embodiments, the composition comprises a binder. In some embodiments, the composition comprises a hydrocolloid. In some embodiments, the composition comprises a vinasse, lignosulfonate, cellulose, anhydrite, sugar, starch, or clay.

In some embodiments, the composition is mixed with one of the aforementioned additional ingredients. In some embodiments, the composition is administered at the same time as one of the aforementioned additional ingredients. In some embodiments, the composition is administered shortly before or shortly after one of the aforementioned additional ingredients.

### Exemplary Formulations of the Disclosure

The present disclosure provides bioprotection compositions in the form of powders, granules or liquid formulations comprising microalgae.

### Liquid Formulations

The present disclosure provides liquid bioprotection compositions comprising microalgae. In some embodiments, the compositions comprise DMS and/or whole-cell microalgae powder. In some embodiments, the compositions comprise diluted DMS. In some embodiments, for the purposes of application to host plants, the compositions comprise about 0.3-0.5% v/v DMS. In some embodiments, the liquid formulation is concentrated and diluted by the grower immediately prior to application.

In some embodiments, the compositions comprise microalgae and CFS. In some embodiments, the liquid formulation comprises DMS and CFS. In some embodiments, the ratio of the CFS to the DMS varies. In some embodiments, the ratio is between 10:1 and 1:10. Exemplary ratios of CFS:DMS include 4:1 and 3:2. In some embodiments, the liquid formulation comprises 10-90% w/w CFS and 10-90% w/w DMS. In some embodiments, the liquid formulation comprises 20-80% w/w CFS and 20-80% w/w DMS. In some embodiments, the liquid formulation comprises about 80% w/w CFS and about 20% w/w DMS. In some embodiments, the liquid formulation comprises about 60% w/w CFS and about 40% w/w DMS.

In some embodiments, the liquid formulation comprising CFS and DMS is diluted in water, e.g., demineralized water. In some embodiments, the liquid formulation is diluted to 0.1%-1.0% v/v in water. In some embodiments, the liquid formulation is diluted to 0.3%-0.5% v/v in water.

In some embodiments, the liquid formulation comprises 0.1-1.0% CFS and comprises about 0.5-30 g/L of whole-cell microalgae powder. In some embodiments, the liquid formulation comprises 10-90% CFS and comprises about 0.5-30 g/L of whole-cell microalgae powder. In some embodiments, the liquid formulation comprises about 0.8-20 g/L of whole-cell microalgae powder.

### Granules

In one aspect, the present disclosure provides granule formulations comprising microalgae. In some embodiments, the composition comprises from about 0.5% to about 5.0% w/w digested microalgae solution (“DMS”). In terms of dry matter, in some embodiments, the composition comprises from about 0.05% to about 0.5% dry matter of microalgae. In some embodiments, the composition comprises about 0.5-5.0% w/w of the ingredients of DMS, e.g., as in FIG. 1A.

In some embodiments, the present disclosure provides agricultural granule compositions comprising microalgae and CFS. In some embodiments, the composition comprises about 0.5% to about 5.0% w/w CFS. In some embodiments, the composition comprises about 0.5%-5.0% of CFS having, e.g., the nutritional profile disclosed in FIG. 1F.

In some embodiments, the granule composition comprises from about 0.5% to about 5.0% w/w mycorrhizae or a powder comprising the mycorrhizae. In some embodiments, the powder comprises 100-10,000 spores/gram. In some embodiments, the granule composition comprises 0.5-500 spores/gram. In some embodiments, the composition comprises 50-500 spores/gram. In some embodiments, the composition comprises 100-300 spores/gram.

In some embodiments, the granule composition is formulated with 0.5-5.0% w/w DMS and 0.5-5.0% w/w CFS and/or 0.5-5.0% mycorrhizae mixed with sufficient quantity of water, e.g., demineralized water, to provide moisture content less than or equal to the absorbent capacity of the solid carrier. In some embodiments, the moisture content is less than or equal to 20%, 15%, 10%, 5% or 1%. For example, in some embodiments, the moisture content is less than or equal to 12% w/w. In some embodiments, the composition comprises more than 50% of a solid carrier. In some embodiments, the composition comprises about 80% to about 95% w/w of a natural clay-based carrier, mineral-based carrier, or other solid substrate such as extruded pellets of organic composition or granules of mineral or synthetic fertilizer. In some embodiments, the composition comprises about 80-95% w/w zeolite or bentonite.

### Methods of Using Bioprotection Compositions Comprising Microalgae

The present disclosure provides methods of using the bioprotection compositions described herein on a host plant. In some embodiments, the methods are used to provide bioprotection to the host plant. In some embodiments, the methods are used to suppress and/or delay pathogenic infection. In some embodiments, the methods are used to upregulate or otherwise improve host plant immunity.

### Host Plants

The methods of the present disclosure may be used on any host plant. In some embodiments, the host plant is an agricultural crop. Agricultural crops include agronomic crops, horticultural crops, and ornamental plants. In some embodiments, a method of the present disclosure is employed on an agronomical crop selected from the list consisting of wheat, rice, corn, soybean, alfalfa, forage crops, beans, sugar beets, canola, and cotton. In some embodiments, a method of the disclosure is employed on a horticultural crop selected from the list consisting of vegetables, fruits, flowers, ornamentals, and lawn grasses. In some embodiments, a method of the disclosure is employed on an ornamental plant selected from the list consisting of flowers, shrubs, grasses, and trees.

Host plants include both monocots and dicots. In some embodiments, the methods of the disclosure are employed on monocots, such as agapanthus, asparagus, bamboo, bananas, corn, daffodils, garlic, ginger, grass, lilies, onions, orchids, rice, sugarcane, tulips, and wheat. In some embodiments, the methods of the disclosure are employed on dicots, such as apples, beans, broccoli, carrots, cauliflower, cosmos, daisies, peaches, peppers, potatoes, roses, sweet pea, and tomatoes. In some embodiments, the agricultural crop is a food crops, feed crop, cereal crop, oil seed crop, pulse, fiber crop, sugar crop, forage crop, medicinal crop, root crop, tuber crop, vegetable crop, fruit crop, or garden crop.

Compositions of the present invention may be applied to any plant or plant propagation material that may benefit from improved growth including agricultural crops, annual grasses, trees, shrubs, ornamental flowers and the like.

In some embodiments, the agricultural crop is selected from cereals, plantation crops, groundnut crops, grams, pulses, vegetables, fruits, proteaginous crops, citrus crops, berry crops, melon crops, vine crops. In some embodiments, the agricultural crop is selected from the list consisting of apple, barley, sunflower, plum, rice, paddy rice, agave, strawberry, watermelon, coffee, tomato, lentil, pea, chickpea, potato, cotton, sugarcane, wheat, banana, soybean, corn, sorghum, onion, carrot, bean, zucchini, lettuce, chicory, fennel, sweet pepper, pear, peach, cherry, kiwifruit, soft wheat, durum wheat, grapevine, table grape, olive, almond, hazelnut, cotton, canola, and maize.

### Application Methods and Application Rates

In some embodiments, the methods comprise applying a dry granule formulation as described herein. The dry granule formulation can be applied to the crops by any suitable means. In some embodiments, the granules are broadcast onto the soil, e.g., by hand or by machine. In some embodiments, the granules are pre-mixed with sand, soil, and/or fertilizer before broadcast. In some embodiments, the compositions are spread, brushed, or sprayed onto the crops or the environs thereof by hand, by apparatus, or by machine. In some embodiments, the dry granule formulation is applied at the rate of 1-100 kg per hectare. In some embodiments, the dry granule formulation is applied at the rate of 5-50 kg per hectare. In some embodiments, the dry granule formulation is applied at the rate of about 10 kg per hectare.

In some embodiments, the present methods comprise applying a seed coating as described herein. In some embodiments, the seed coating is applied to the seeds before planting, e.g., using a mixer. In some embodiments, the seed coating is applied in furrow, e.g., via suitable broadcast or in-furrow application means. In some embodiments, the seed coating is applied using flow equipment after suspension in a liquid carrier. In some embodiments, the seed coating is applied at the rate of about 10 g to 1 kg of dry powder seed coating per quantity of seeds to be planted in one hectare. In some embodiments, the seed coating is applied at the rate of about 50-200 g of dry powder seed coating per quantity of seeds to be planted in one hectare. In some embodiments, the seed coating is applied at the rate of about 100 g of dry powder seed coating per quantity of seeds to be planted in one hectare.

In some embodiments, the present methods comprise applying a liquid formulation as described herein. In some embodiments, the liquid formulation is applied at a rate of 100 mL to 100 L per hectare. In some embodiments, the liquid formulation is applied at a rate of 0.5 L to 10 L per hectare. In some embodiments, the liquid formulation is applied at a rate of about 4-7 L per hectare. In some embodiments, the liquid formulations herein are diluted in water or a suitable liquid carrier prior to application. For example, In some embodiments, the liquid formulations are diluted to 0.1-1.0% v/v before application to the host plant, plant parts, or plant environs. In some embodiments, the liquid formulations are diluted to 0.3-0.5% v/v before application.

The compositions of the present disclosure may be applied to any part of a host plant or the environs thereof. In some embodiments, in the case of granules, the compositions are applied to the roots and/or the soil around the host plant. In some embodiments, in the case of seed coatings, the compositions are applied to the seeds of the host plant before, during or shortly after planting. In the case of liquid compositions, the compositions may be applied to the seeds, seedlings, plants, or plant parts. Plant parts include seeds, seedlings, plant tissues, leaves, branches, stems, bulbs, tubers, roots, root hairs, rhizomes, cuttings, flowers, and fruits. Compositions of the present invention may further be applied to any area where a plant will grow including soil, a plant root zone and a furrow.

The compositions of the present disclosure can be applied at any time during the host plant life cycle. In some embodiments, the compositions of the present disclosure are applied shortly after planting, tillering, or sowing. In some embodiments, the compositions of the present disclosure are applied as a seed coating or soil treatment around the time of planting. In some embodiments, the compositions are applied 0-30 days after planting, sowing, or tillering. In some embodiments, the compositions are applied pre-blooming. In some embodiments, the compositions are applied post-blooming. In some embodiments, the compositions are applied at rooting, sprouting, flowering, fruit setting, ripening, or fattening. in some embodiments, the compositions are applied before or during a peak period of metabolic activity. In some embodiments, the compositions are applied during a period of host plant stress.

In some embodiments, the compositions are applied more than once. In some embodiments, the composition is administered 3 to 5 times per growing cycle, depending on the type of crop, the intensity, and the planting. In some embodiments, the compositions are applied periodically throughout the growing cycle. The compositions may be applied once a day, once a week, once every two weeks, or once a month. In some embodiments, the timing of composition application is based on field studies assessing the efficacy of application at different time points. In some embodiments, the compositions are applied 1-10 times throughout the growing cycle of the host plant. In some embodiments, the compositions are applied 1-5 times throughout the growing cycle of the host plant.

In some embodiments, application to plants, plant parts, plant tissues, or plant environs comprises soil application pre-blooming and application to aerial biomass post-blooming. In some embodiments, compositions intended for soil are applied pre-blooming, such as granules or liquid soil treatments, and compositions intended for aerial dispersion are applied post-blooming, such as foliar sprays.

### Bioprotection Methods

In some embodiments, the present methods are used as a means of bioprotection. In some embodiments, the methods improve host plant immunity. In some embodiments, the methods lead to an upregulation of genes involved in host plant immunity. In some embodiments, the methods suppress or delay infection by a pathogen.

In some embodiments, disclosed methods may be useful in reducing the damage to host plants, i.e., protecting host plants (e.g., agricultural plants) from one or more bacterial diseases. Exemplary bacteria include, but are not limited to, Pseudomonas avenae, Xanthomonas campestris, Enterobacter dissolvens, Erwinia carotovora, Pseudomonas syringae, Clavibacter michiganensis, Pseudomonas syringae, Bacillus subtilis, Erwinia stewartii, Spiroplasma kunkelli, Pseudomonas amygdali, Curtobacterium flaccumfaciens, and Ralstonia solanacearum.

In some embodiments, disclosed methods may be useful in reducing the damage to host plants, i.e., protecting plants, (e.g., agricultural crops) from one or more fungal diseases. Exemplary fungi include, but are not limited to, Colletotrichum graminicola, Aspergillus flavus, Rhizoctonia solani, Acremonium strictum, Lasiodiploda theobromae, Marasmiellus sp., Physoderma maydis, Acremonium strictum, Macrophomina phaseolina, Thanatephorus, Curvularia clavata, Didymella exitalis, Diplodia maydis, Stenocarpella macrospora, Sclerophthora rayssiae, Sclerophthora macrospora, Sclerospora graminicola, Peronosclerospora maydis, Peronosclerospora philippinensis, Peronosclerospora sorghi, Peronosclerospora spontanea, Peronosclerospora sacchari, Nigrospora oryzae, Alternaria alternate, Claviceps gigantean, Aureobasidium zeae, Fusarium subglutnans, Fusarium moilforme, Fusarium avenaceum, Gibberella zeae, Botryosphaeria zeae, Cercospora sorghi, Exserohilum pedicellatum, Cladosporium cladosporioides, Hyalothyridium maydis, Cephalosporium maydis, Setsphaeria turcica, Cochliobolus carbonum, Penicillium spp., Phaeocytostroma ambiguum, Phaeosphaeria maydis, Botryosphaeria, Diplodia frument, Phoma terrestris, Phythium spp., Pythium aphanidermmatum, Epicoccum nigrum, Rhizoctonia zeae, Rhizoctonia solani, Setosphaeria rostrata, Puccinia sorghi, Puccinia polysora, Physopella pallescens, Sclerotium rolfsii, Bipolaris sorokiniana, Selenophoma sp., Gaeumannomyces graminis, Myrothecium gramineum, Monascus purpureus, Ustilago zeae, Ustilaginoidea vixens, Sphacelotheca reiliana, Cochliobolus heteroostrophus, Stenocarpella macrospora, Cercospora sorghi, Aspergillus spp., Phyllachora maydis, Trichoderma viride, Stenocarpella maydis, Ascochyta ischaemi, Alternaria spp., Colletotrichum truncatum, Arkoola nigra, Thielaviopsis basicola, Septoria glycines, Phialophora gregata. Macrophomina phaseolina, Choanephora infundibulifera, Pythium ultmum, Peronospora manshurica, Drechslera glycines, Cercospora sojina, Fusarium spp., Leptosphaerulina trifolii, Mycoleptodiscus terrestris, Neocosmospora vasinfecta, Phomopsis spp., Phytophtora sojae, Phymatotrichopsis omnivore, Diaporthe phaseolorum, Microsphaera diffusa. Cercospora kikuchi, Pyrenochaeta glycines, Pythium aphanidermatum, Cylindrocladium crotalariae, Dactuliochaeta glycines, Rhizoctonia solani, Phakopsora pachyrhizi, Spaceloma glycines, Sclerotinia sclerotiorum, Sclerotium rolfsii, Diaporthe phaseolorum, Stemphylium botryosum, Fusarium solani, Corynespora cassiicola, Nematospora coryli, and Cloeocercospora sorghi.

In some embodiments, the compositions and methods of the disclosure are useful in suppressing, reducing, delaying, preventing, or treating infection by a pathogen from a genus selected from the list consisting of: Albugo, Alternaria, Aphanomyces, Aschochyta, Aspergillus, Bipolaris, Blumeria, Botrytis, Cercospora, Colletotrichum, Didymella, Erysiphe, Fusarium, Leptosphaeria, Magnaporthe, Melampsora. Microdochium, Mycosphaerella, Peronospora, Phakopsora, Phytophthora, Plasmodiophora, Plasmopara, Puccinia, Pyrenophora, Pythium, Rhizoctonia, Rhizopus, Septoria, Sclerotium, Stemphylium, Tilletia, Uromyces, Ustilago, and Venturia. In some embodiments, the compositions and methods of the disclosure are useful in suppressing, reducing, delaying, preventing, or treating infection by a pathogen of a species selected from the list consisting of Ascochyta rabei, Alternaria carthami, Bipolaris sorokiana, Botrytis cinerea, Pyrenophora teres, and Rhizopus stolonifer.

In some embodiments, disclosed methods may be useful in reducing the damage to host plants, i.e., protecting plants (e.g., agricultural crops) from one or more parasitic nematodes. Exemplary parasitic nematodes include, but are not limited to, Dolichodorus spp., Ditylenchus dipsaci, Radopholus similis, Heterodera avenae, Xiphinema spp., Nacobbus dorsalis, Hoplolaimus Columbus, Hoplolaimus spp., Pratylenchus spp., Longidorus spp., Circonemella spp., Meloidogyne spp., Helicotylenchus spp., Belonolaimus spp., Paratrichodorus spp., Tylenchorhynchus dubius, Paratylenchus projectus, Rotylenchulus reniformis, Criconemella ornate, Meloidogyne arenaria, Hemicycliophora spp., Heterodera glycines, Belonolainus gracilis, Paratrichodorus minor, and Quinisulcius acutus.

Bioprotection, such as enhanced antifungal, antimicrobial, or antinematocidal activity or reduction of damage to plants from pathogens or pests, provided to plants by compositions disclosed herein, may be useful at a variety of different stages of plant growth. For example, enhanced antimicrobial activity may be useful in the management of and/or protection from fungal infections and molds in storage, e.g., of seeds and tubers. Without treatment with compositions disclosed herein, these fungi and molds may be directly transported with the seeds or transported with the seeds to the soil upon planting. Additional examples of relevant applications include, but are not limited to, in the management of bacterial infections (e.g., brown rot or erwinia) or algae in storage and/or at planting, in the protection of seed tubers (e.g., potatoes) from bacterial infections (e.g., brown rot or erwinia) or algae in storage and/or at planting, in the treatment of pieces of seed tubers (e.g., potatoes) before and when planting, and in the treatment of soil and/or irrigation water in fields or greenhouses for common plant pathogens endemic in the growing environment (e.g., human infection management coliform or enterobacter, salmonella, etc.).

In some embodiments, the methods and compositions herein are useful in providing bioprotection against pathogenic infection of any host plant or plant part during or following growing. In some embodiments, the methods are useful in providing protection from pathogenic infection in seeds, seedlings, plant tissues, leaves, branches, stems, bulbs, tubers, roots, root hairs, rhizomes, cuttings, flowers, or fruits. In some embodiments, the methods suppress or delay infection in harvested fruit. In some embodiments, the methods suppress or delay infection in plant leaves, seeds, roots, or stems.

In some embodiments, the methods and compositions herein decrease percent infection per leaf, percent infection per plant, number of infected leaves per plant, lesion size of infection, number of infected lesions, number of infected fruit, or percent of infected fruit. In some embodiments, a parameter is decreased by 5-90%.

### Improvements in Host Plant Response to Abiotic Stress

The present disclosure provides methods of improving a host plant's tolerance to abiotic stress. In some embodiments, the method upregulates expression of genes involved in response to abiotic stress. In some embodiments, the method upregulates expression of genes involved in response to abiotic stimulus, response to water deprivation, or response to stress. In some embodiments, the method improves host plant nutrient utilization, thereby allowing the host plant to better tolerate abiotic stress.

Abiotic stress includes water stress, temperature stress, sun stress, salinity stress, wind stress, and heavy metal stress. Examples of abiotic stress include drought, heat, cold, excess salinity, strong winds, heavy metals, flooding, and excessive sunlight.

In some embodiments, the present methods improve resistance to abiotic stress. In some embodiments, the present methods improve resistance to temperature stress. In some embodiments, the present methods improve resistance to water stress. In some embodiments, the present methods improve resistance to salinity stress. In some embodiments, the present methods improve resistance to sun stress. In some embodiments, the present methods improve resistance to wind stress. In some embodiments, the present methods improve resistance to heavy metal stress.

### EXAMPLES

### Example 1: Formulation of Illustrative Components of Compositions of the Disclosure

Whole-cell microalgae powder. A microalgae consortium comprising genera from the list of Chlorella, Scenedesmus, Nannochloropsis, Muriellopsis, Isochrysis, Tisochrysis, Desmodesmus, Haematococcus, Arthrospira, and Anabaena was cultured in photobioreactors supplemented with nutrients and CO₂. The microalgae were harvested once the biomass reached 0.5-5.0 g/L. Culture solids comprising whole microalgae cells were then separated from solution, dried, and ground to an average particle size of about 100-1000 microns in order to produce a mostly whole cell powder form of microalgae, i.e., “whole-cell microalgae powder.”

Digested microalgae solution. The whole cell microalgae powder was then processed to degrade cell walls and proteins, thereby increasing the concentration of accessible organic carbon, amino acids and peptides and producing a digested microalgae solution (“DMS”) of the disclosure. A nutrient analysis of an illustrative DMS is shown in FIG. 1A.

Liquid microalgae applications. For liquid microalgae applications, e.g., in the form of foliar sprays, the DMS was typically diluted to 0.3-0.5% v/v with demineralized water and optionally a buffer.

Microbial culture cell-free supernatant. Microbial consortia such as IN-M1 deposited with ATCC Patent Deposit No. PTA-12383 or IN-M2 deposited with ATCC Deposit No. PTA-121556 were cultured as described in U.S. Pat. Nos. 10,588,320 and 10,561,149, incorporated by reference herein in their entireties. Cell-free supernatant (“CFS”) was obtained by centrifuging the microbial culture for at least 10 minutes at a centrifugal force of about 14,000 g. The CFS composition was then checked by absorbance (600 nm) to determine whether any microbes were still present and the liquid portion was removed via decanting or pipetting. The supernatant was then filter sterilized with a 0.22 μM micron filter.

The chemical characterizations of the cell-free supernatant compositions made from microbial cultures comprising IN-M1 and IN-M2 were determined. The cell-free supernatant compositions had fairly high levels of potassium (about 2500 μg per gram of composition), followed by nitrogen (435-600 μg per g composition), calcium (475-660 μg per g composition) and magnesium (200-260 μg per g composition). Sodium ranged from 160 to 360 ppm. The pH ranges were similar at 4.3-4.5. Sulphur was present at near 425-500 ppm in the cell-free supernatant compositions tested. Phosphorus was present in very low levels (50-90 ppm). All other metals were at trace levels, except iron which was present at about 20 ppm. An analysis of an illustrative cell-free supernatant is presented in FIG. 1F.

### Example 2: Formulation of Illustrative Combined Digested Microalgae Solution and Cell Free Supernatant Compositions of the Disclosure

DMS and CFS were formulated according to Example 1. These components were mixed in various ratios of DMS to CFS, with nutrient analysis of each one presented in FIG. 1B-1E: 79%/21% (FIG. 1B), 50%/50% (FIG. 1C), 40%/60% (FIG. 1D), and 30%/70% (FIG. 1E).

For application to agricultural crops, such combinations of DMS and CFS can be diluted to 0.3%-0.5% v/v with water separately or after combination.

### Example 3: Suppression of Fungal Infection in Non-Wounded and Wounded Detached Grape Assays

### Materials and Methods

Grape Cultivar—Thompson Seedless

Pathogen—Botrytis cinerea

Application of DMS—Concentration of DMS was 0.3% in water. DMS was sprayed onto grapes using a hand held atomizer and allowed to dry over a time period of approximately 2 hours prior to fungal inoculation.

Fungal inoculum preparation—500 μL of water was washed into 3-5 day old culture plate. Liquid was pipetted off and mixed in Eppendorf tube. 10 μL of this suspension was used as the inoculum per grape, comprising both spores and hyphae, with an estimated dose of 10⁸ spores per inoculation.

Non-wounded inoculation—Fungal inoculum was placed onto the surface of the grape without any wounding.

Wounded inoculation—A puncture wound was made into the surface of the grape with a needle, and a fungal inoculum is placed onto the wound.

Assessment—Grapes were kept at room temperature and observed over the course of 5 days.

### Results

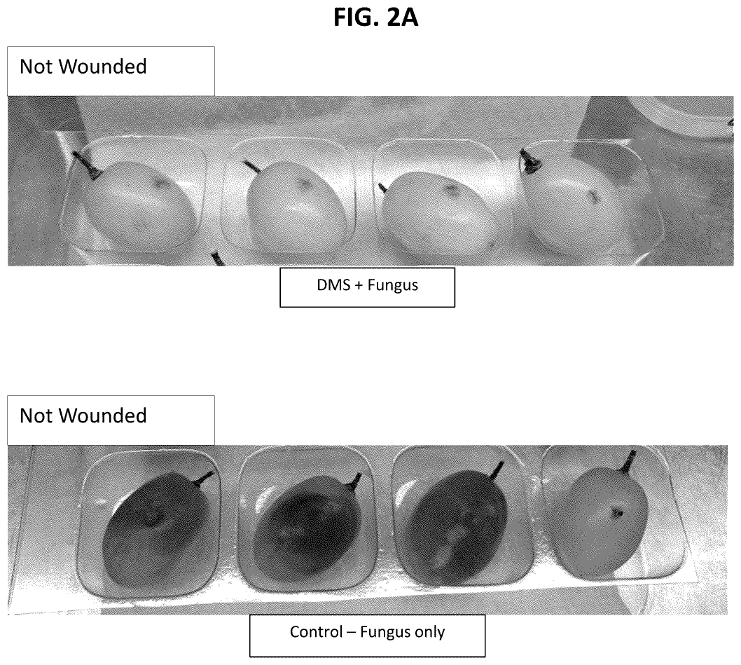

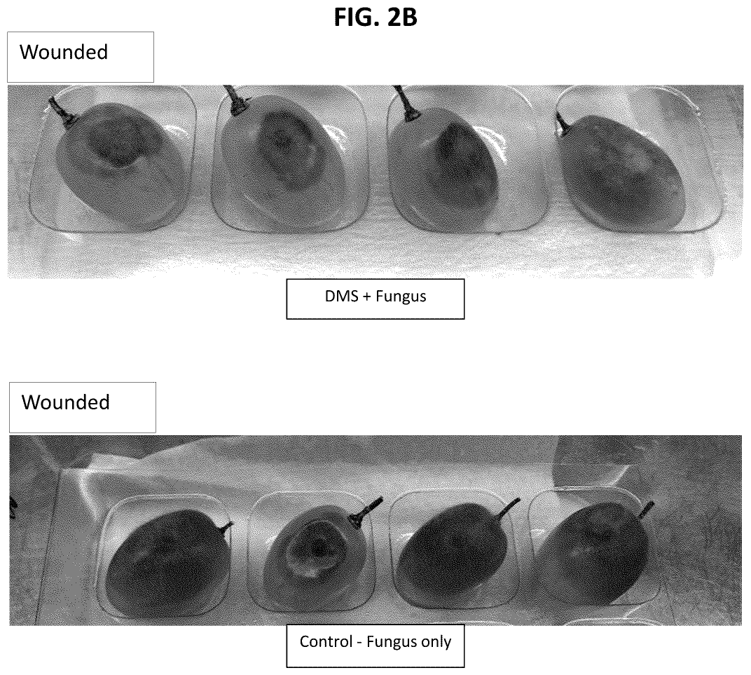

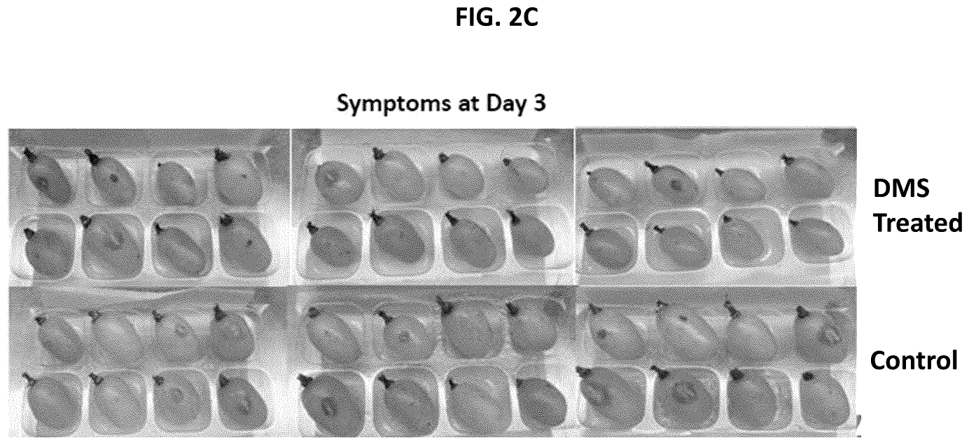

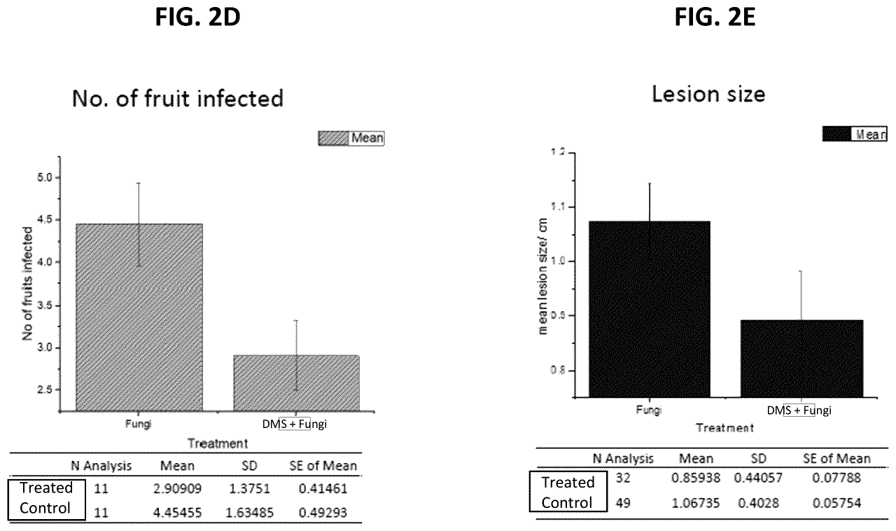

FIG. 2A shows the results from the non-wounded assay with Botrytis cinerea fungal exposure, demonstrating a dramatic and visible decrease in the degree of infection for DMS-treated grapes. In the wounded assay, pathogenic infection and progression is favored. In spite of this, FIG. 2B shows the results of the wounded assay demonstrating suppression/delay of Botrytis cinerea infection in DMS-treated wounded grapes compared to the untreated control.

### Example 4: Statistically Significant Suppression of Fungal Infection in Non-Wounded Detached Grape Assay

### Materials and Methods

Grape Cultivar—Thompson Seedless, Crimson Red

Pathogen—Botrytis cinerea

Concentration of DMS—0.3% in water

Application—Grapes were not wounded and were surface sterilized. Diluted DMS was sprayed on grapes and allowed to dry for 2 hours before exposure to fungal inoculum. The fungus was administered as in Example 3 with a liquid comprising 10³ conidia/mL. The assay was performed in 4 independent trials. Among the four trials, a total of 88 fruit were tested per treatment condition. Number of infected fruit and lesion size of infection were evaluated at day 5 after exposure. Lesion size was assessed using the longitudinal length of the necrotic patch.

### Results

Suppression and delay of disease occurrence was observed in all four trials. FIG. 2C shows an image of exemplary symptoms at day 3 for a sampling of the tested fruit. FIG. 2D and FIG. 2E show the number of infected fruit and lesion size, respectively, showing a statistically significant (p<0.05) decrease in both parameters at day 5 for the DMS-treated fruit compared to control: p=0.026 for number infected and p=0.031 for lesion size.

### Example 5: Suppression of Fungal Infection in Safflower Whole Plant Assay

### Materials and Methods

Safflower Cultivar—Montola 2003

Pathogen—Alternaria carthami

Concentration of DMS—0.3% in water

DMS Application—Diluted DMS was sprayed on leaves of live safflower plants and allowed to dry for 2 hours before exposure to fungal inoculum.

Fungal inoculation—The fungus was administered as a liquid comprising fungal spores. 15 plants were tested in each treatment group. 314 leaves were assessed in the DMS-treated condition; 416 leaves were assessed in the control untreated condition.

Assessment of infection—Percent infection per leaf, percent infection per plant, and number of infected leaves per plant were assessed on day 14 after fungal inoculation.

### Results

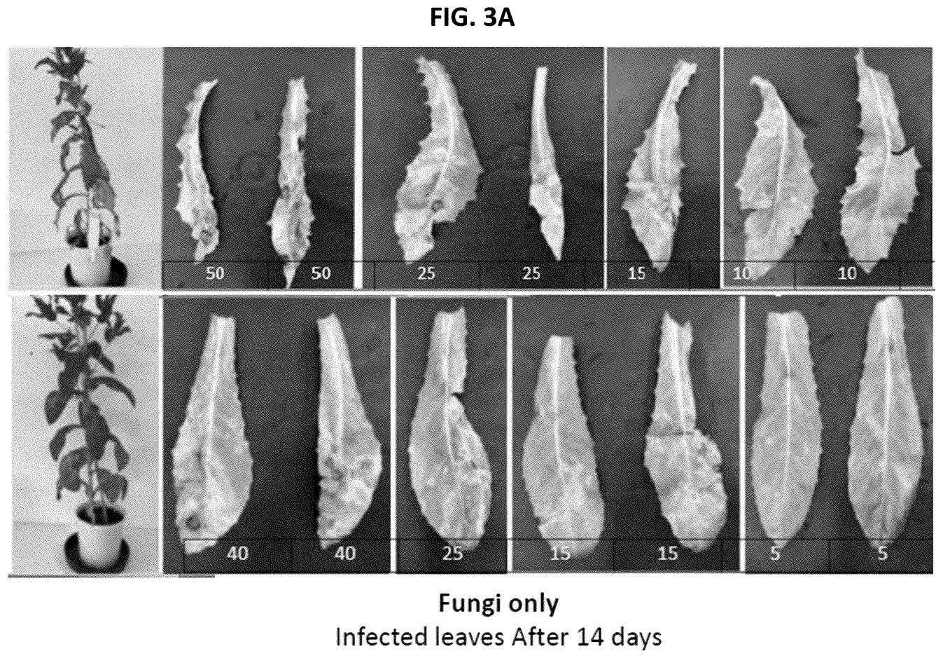

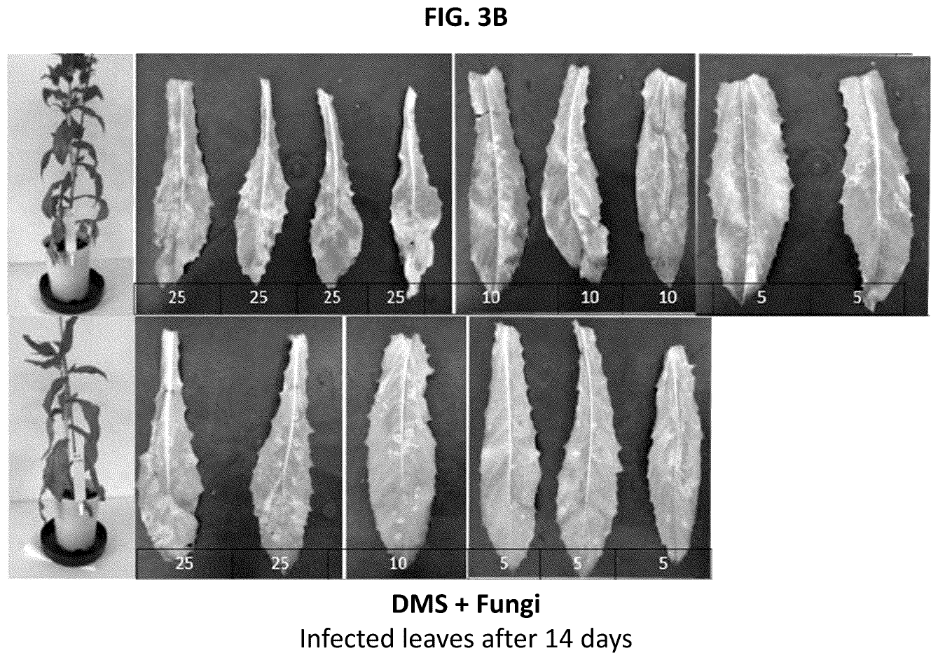

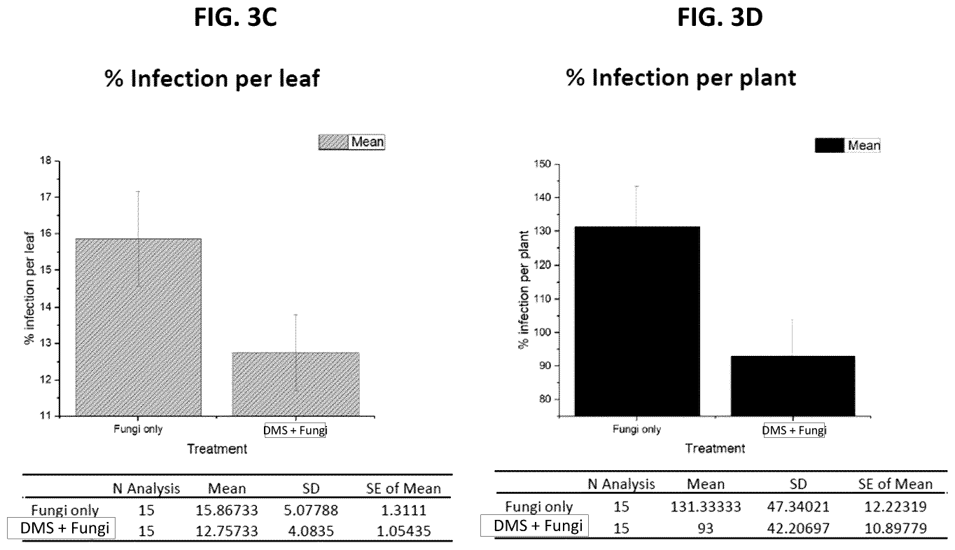

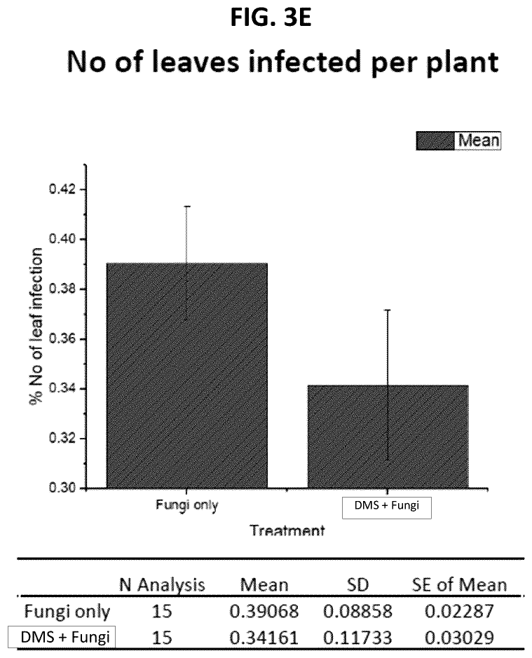

Application of an illustrative microalgae composition of the disclosure significantly reduced the degree of Alternaria infection in safflower plants. FIG. 3A shows exemplary leaves from untreated control plants and FIG. 3B shows exemplary leaves from DMS-treated plants. The leaves were graded for percent infection of leaf area, with FIG. 3B showing visibly lower infection in the treated condition. FIG. 3C-3E show the results averaged across all tested leaves/plants for percent infection per leaf, percent infection per plant, and number of infected leaves per plant, respectively. All three parameters were lower for the treated condition, with a statistically significant result for both percent infection per leaf (p<0.1, p=0.075) and percent infection per plant (p<0.05, p=0.026).

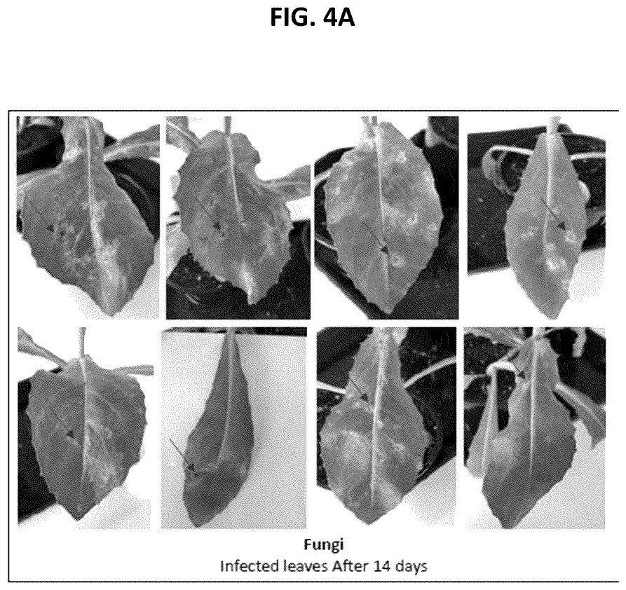

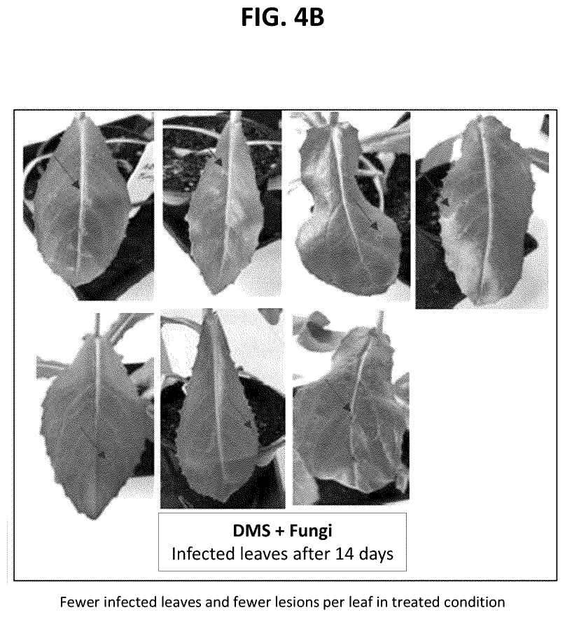

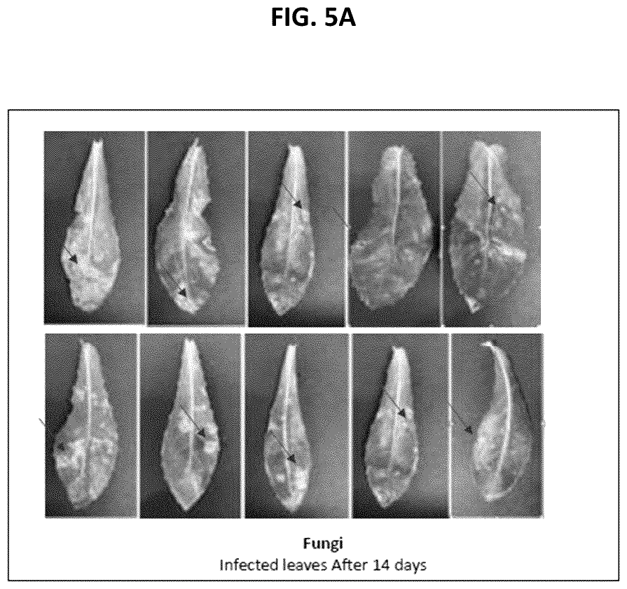

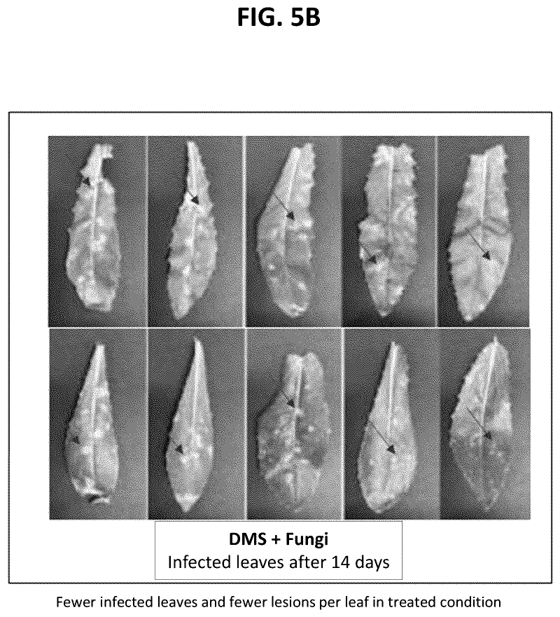

In additional trials on whole safflower plants, the efficacy against two 3-week old and two 8-week old safflower plants was evaluated using the same DMS application and fungal inoculation methods described above. Bags were placed over the leaves for 24 hours after inoculation. The oldest leaves were scored at 14 days after inoculation. The results for 3 week old plants are shown in FIG. 4A-4B, while the results for 8 week old plants are shown in FIG. 5A-5B. In both cases, fewer infected leaves and fewer lesions per leaf were observed in the treated condition.

### Example 6: Microalgae Composition Applied in Fungal Assays in Tomato

### Materials and Methods

Tomato Cultivars—Siberian, Mortgage lifter, Roma

Pathogen—Alternaria sp.

Concentration of DMS—0.3%-1.0% in water

DMS Application—Diluted DMS was sprayed on whole plants or detached young leaves of tomato plants and allowed to dry for 2 hours before exposure to fungal inoculum. Leaves were not surface sterilized.

Fungal inoculation—In the detached leaf assay, leaves were wounded and the fungus was administered as a plug in each leaf. In the whole plant assay, a fungal spore solution was sprayed on all leaves of 4 week old Siberian tomato plants.

Infection measurements—In the detached leaf assay, lesion size on leaves was measured on day 3 or day 5 after infection. In the whole plant assay, number of infected leaves and lesion size were measured on day 7 after infection.

### Results

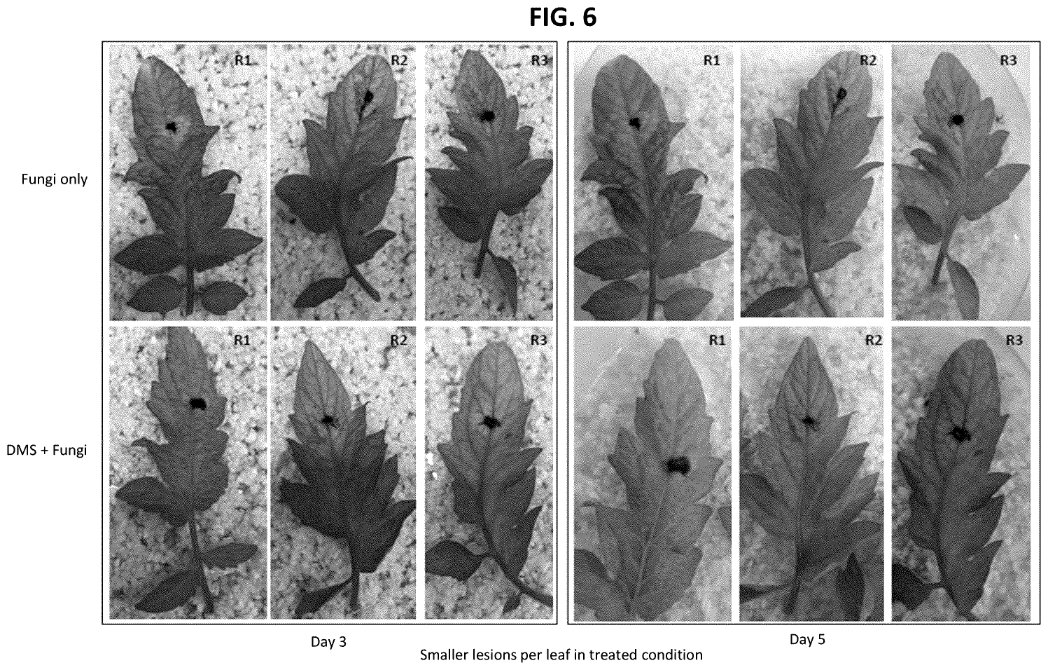

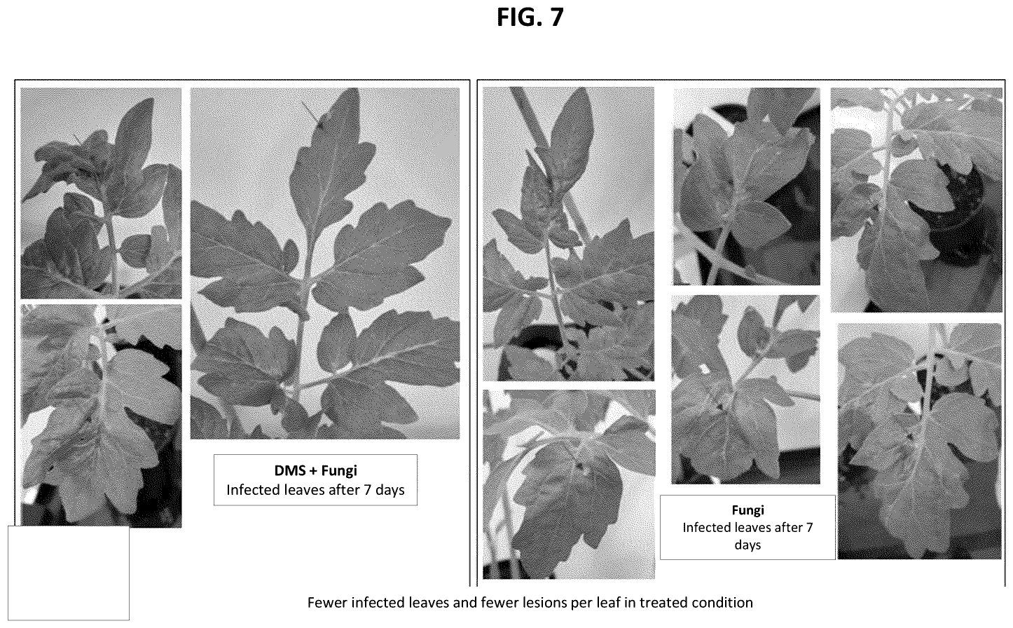

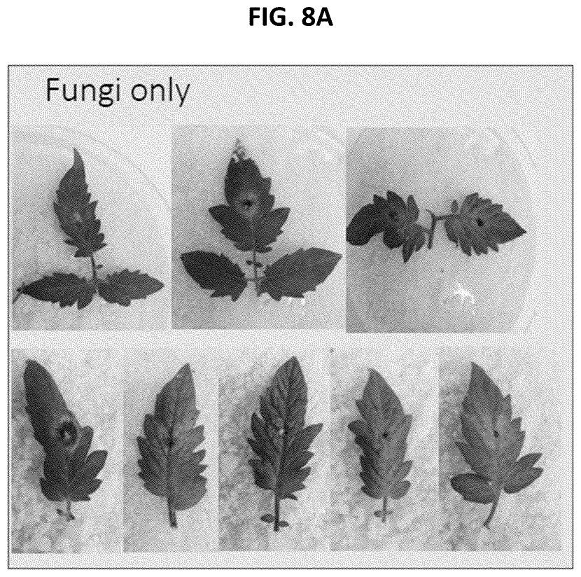

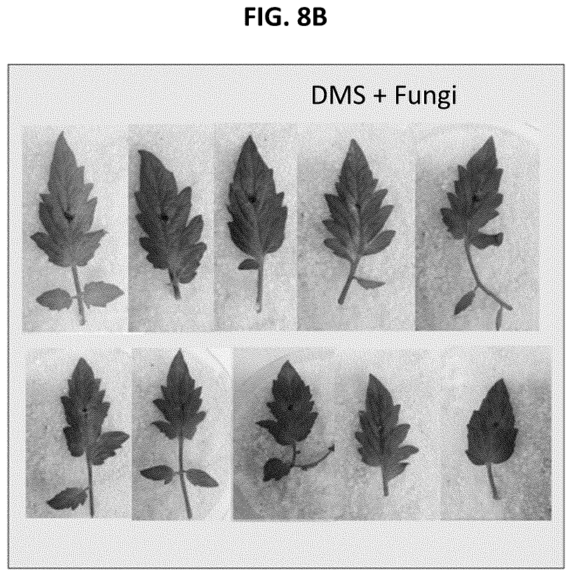

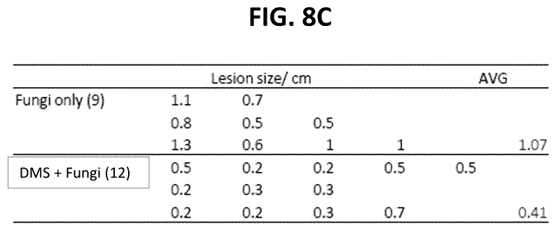

FIG. 6 shows images of a detached leaf assay in Siberian tomato leaves in which suppression/delay of infection was observed. In this trial, smaller lesion sizes per leaf were observed in the treated condition compared to the control. FIG. 7 shows exemplary images from the whole plant assay in Siberian tomato plants, in which suppression/delay of infection was observed with fewer infected leaves and fewer lesions per leaf in the treated condition. In additional detached leaf assays, inhibition of fungal infection was observed in 2 out of 5 trials for the Siberian cultivar; 2 out of 3 trials for Mortgage lifter cultivar; and 1 out of 3 trials for Roma cultivar. In trials where suppression was not observed, there was no exacerbation of infection. FIG. 8A-SC show the results from an additional trial in Siberian leaves in which suppression was observed.

### Example 7: Suppression of Fungal Infection in Detached Fruit Assay in Almonds

### Materials and Methods

Almond Cultivar—Nonpareil

Pathogen—Rhizopus stolonifera

Concentration of DMS—0.3%-1.0% in water

DMS Application—Diluted DMS was sprayed on almond nuts and allowed to dry for 2 hours before fungal inoculation (pre-pathogen application) or it was applied 24 hours after fungal inoculation.

Fungal inoculation—Fungal spores were sprayed over almond nuts at the hull split, with 30 nuts per treatment condition.

Infection measurements—Number of infected nuts out of 30 was measured at day 3, day 6, and day 8 post-inoculation. Percent inhibition compared to control was calculated.

### Results

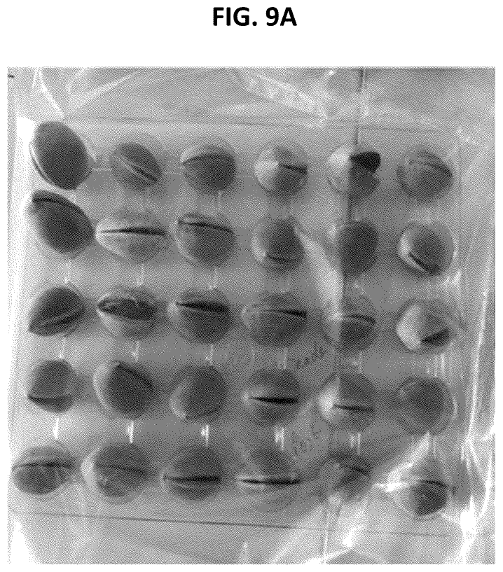

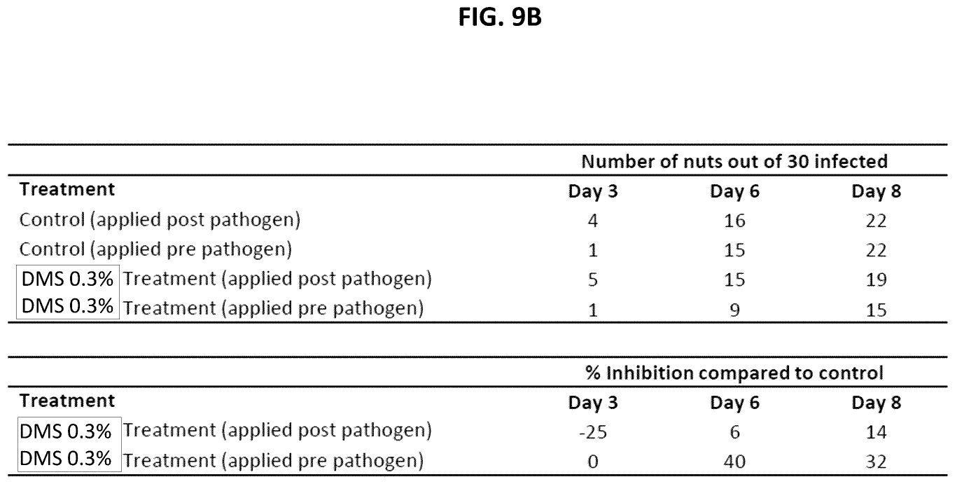

Application of DMS, either before or after inoculation with the pathogen, decreased number of infected nuts compared to control at days 6 and 8. FIG. 9A shows an image of the almond nuts in one of the treatment conditions. FIG. 9B show the numerical results of infected nuts at each time point, demonstrating that application of DMS pre-pathogen resulted in improved suppression of infection at all time points compared to application post-pathogen.

### Example 8: Farmer Rice Paddy Field Trial Demonstrates Decreased Blast Infection

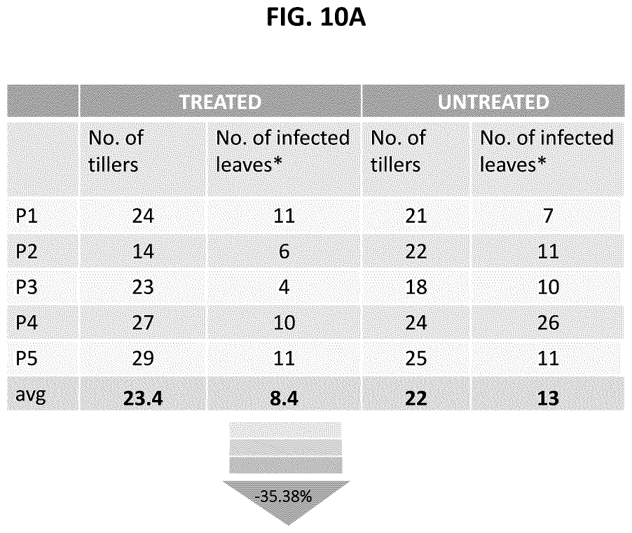

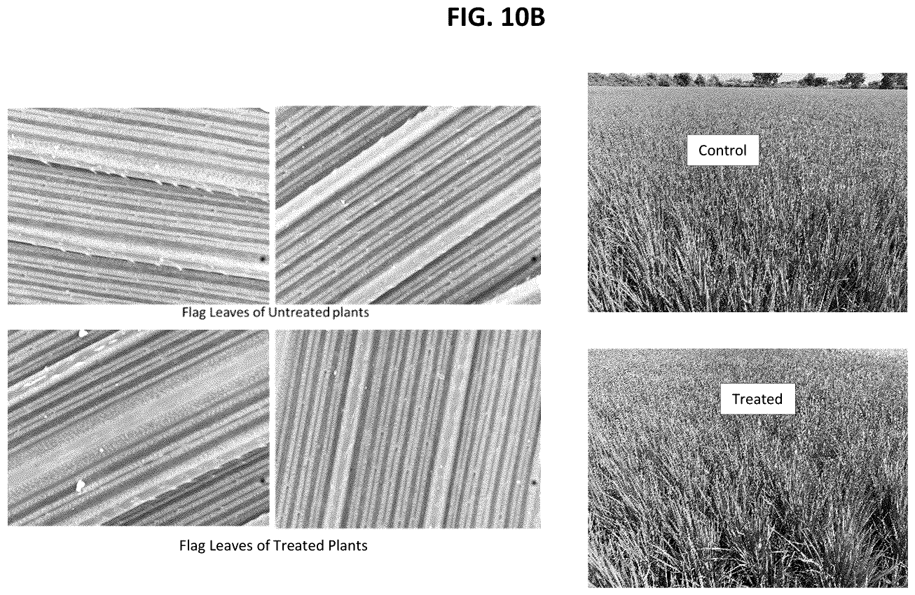

The DMS of Example 1 was combined with arbuscular mycorrhizal fungi on bentonite granules and applied to a rice paddy four days after transplant at a rate of 4 kg/ha. At about 60 days after transplant, the number of infected leaves was significantly lower in the treated plants than in the untreated control. See FIG. 10A. At a second visit about 80 days after transplant, there was no significant difference in numbers of tillers, but there was a remarkable and statistically significant decrease (68%) in the number of blast infected leaves. There was also a significant difference in the color of the flag leaves of mother tillers. See FIG. 10B. Overall, the crops were healthier, more vigorous, and greener than the control.

### Example 9: In Vitro Bioprotection Assay Shows No Direct Fungicidal Activity from Illustrative Microalgae Composition

### Materials and Methods

An in vitro bioprotection assay was established to evaluate the direct activity of DMS against three plant pathogenic fungi: Botrytis cinerea, Alternaria carthami, and Alternaria sp. Each fungal strain was cultured on potato dextrose agar (Oxoid) for 5-7 days at room temperature (23° C.). The assay was conducted on Reasoners 2 agar (R2A, Oxoid), with DMS evaluated as either a 0.3% solution or the undiluted (neat) product. A total of two 6 mm diameter×5 mm depth wells were created in the R2A at a distance of 25 mm from the center of the plate across the same plane. A total of 100 μL of DMS was placed into a well, while 100 μL of sterile distilled water was placed into a well for the control. A 6 mm diameter agar plug with actively growing mycelia from the fungi was placed at the center of the plate. The bioassay was incubated at room temperature (23° C.), and then the diameter of the fungal colony on the plate was recorded after 2 days of growth. For each treatment three plates were prepared as biological triplicates.

### Results

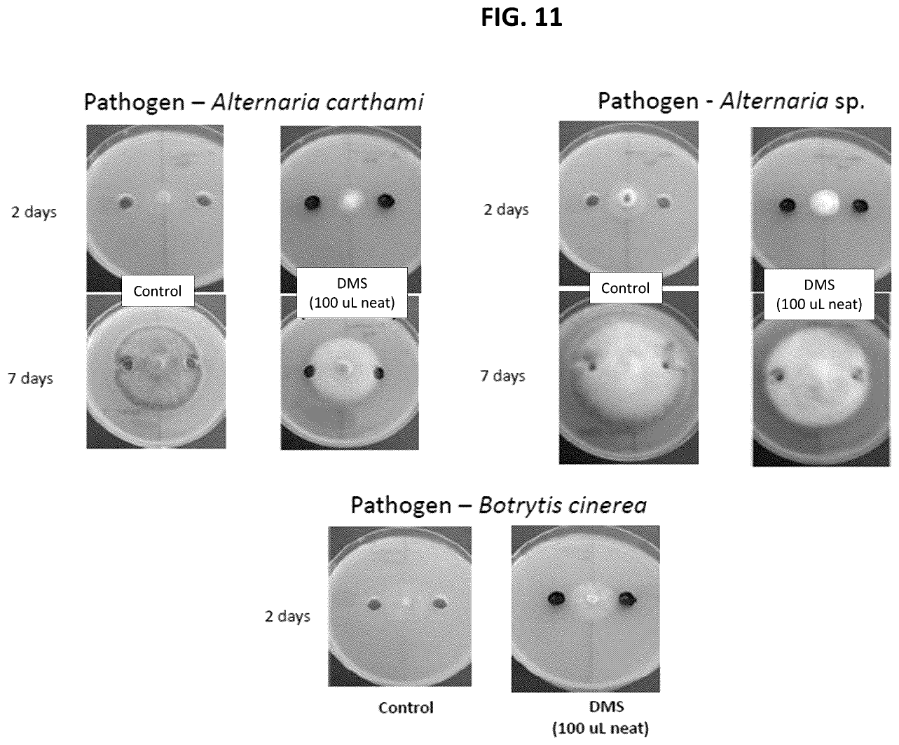

DMS did not directly inhibit fungal growth, thereby demonstrating that the composition does not have direct fungicidal properties against any of these strains. See FIG. 11, showing no observable decrease in growth of fungal culture. These results support a mechanism of action involving the host plant immune response underlying the bioprotection/fungal inhibition observed after its application to plant hosts in the above Examples.

### Example 10: Genes Upregulated in Systemic Acquired Resistance, Pipecolic Acid Production after Application of Illustrative Microalgae Composition

### Materials and Methods

Arabidopsis RNAseq experiment. 0.3% DMS applied to juvenile and mature Arabidopsis thaliana, which were compared to control untreated plants. RNAseq was performed on plant leaves 2 hours and 24 hours after application. The data quality was excellent with 99.54% of reads retained after read trimming and more than 95% of reads mapped for most samples using the Gydle nuclear algorithm. Over 25,000 transcripts were mapped per sample, about 52% of total. The number of transcripts per gene was assessed in each of the samples and averaged among the replicates in the same treatment condition.

Up regulated genes were defined as those for which the average number of transcripts in the treated plant divided by the average value for control was greater than 2, and the average number of transcripts in the treated condition was over 10. Down regulated genes were defined as those for which the average value for treatment divided by the average value for control was less than 0.5, and the average value for control was over 10.

GO term enrichment was assessed using the Panther Gene Ontology database by identifying the number of genes for that GO term that were identified in the treated sample, and comparing that to the expected number given the total number of genes identified in the sample and the total number of genes belonging to that GO term in the genome.

### RNAseq Results in Arabidopsis

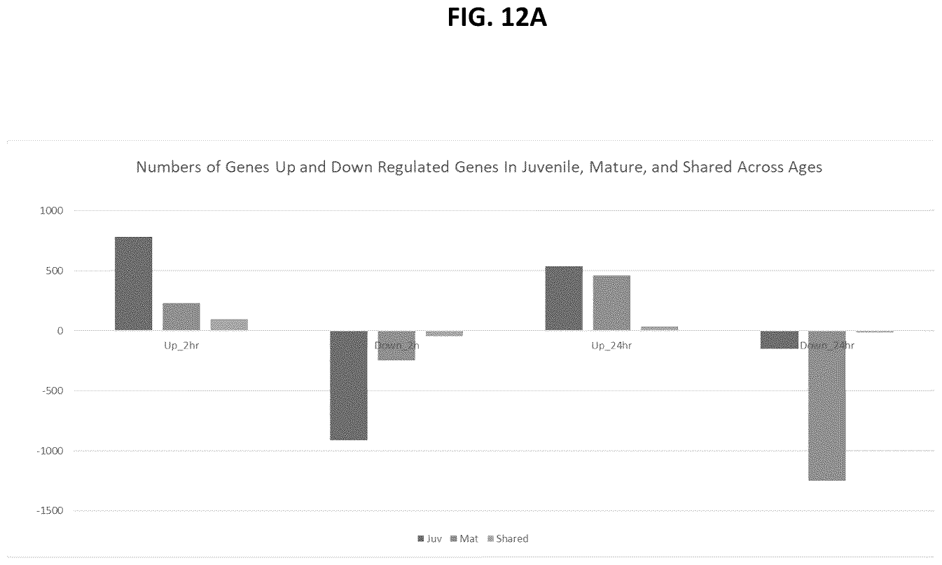

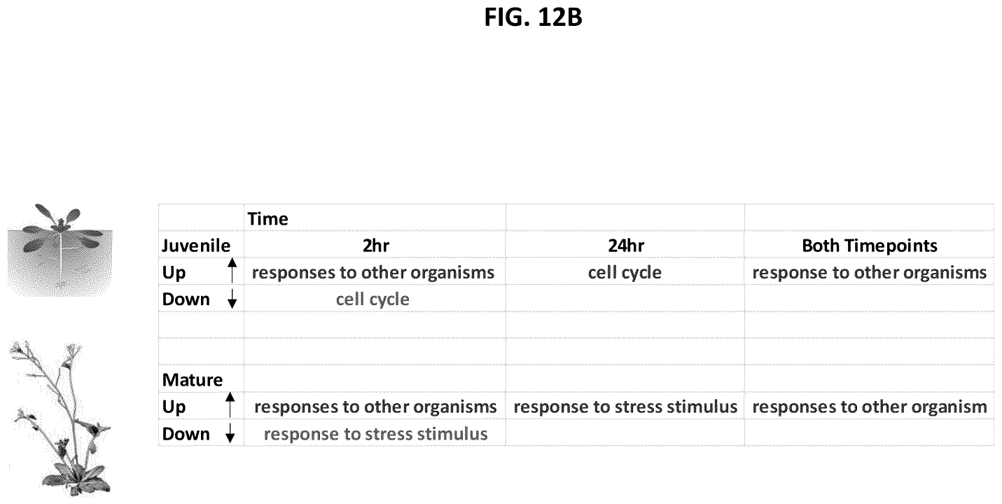

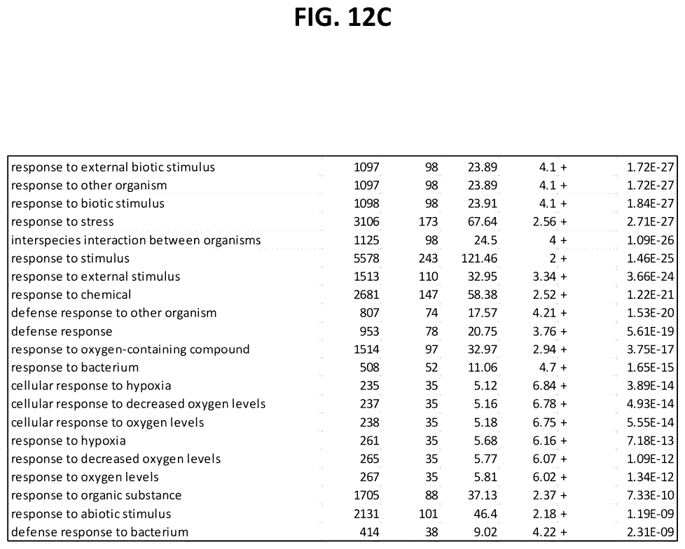

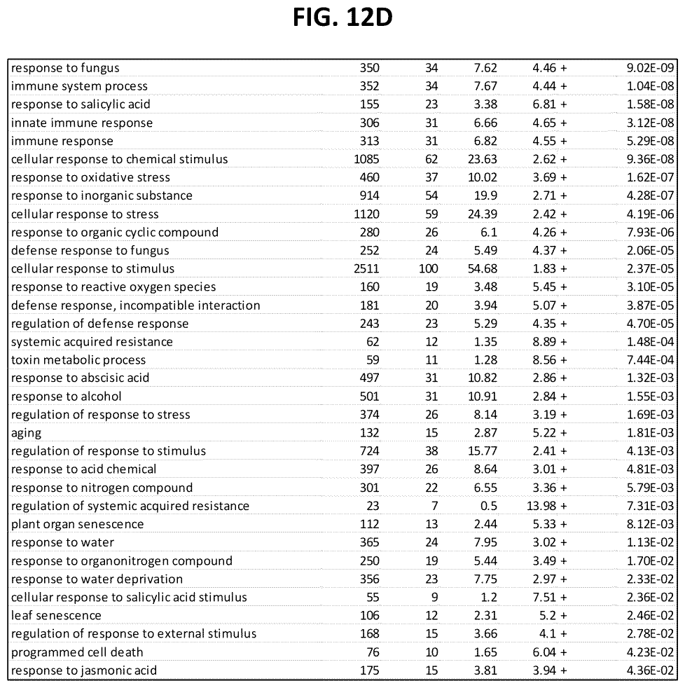

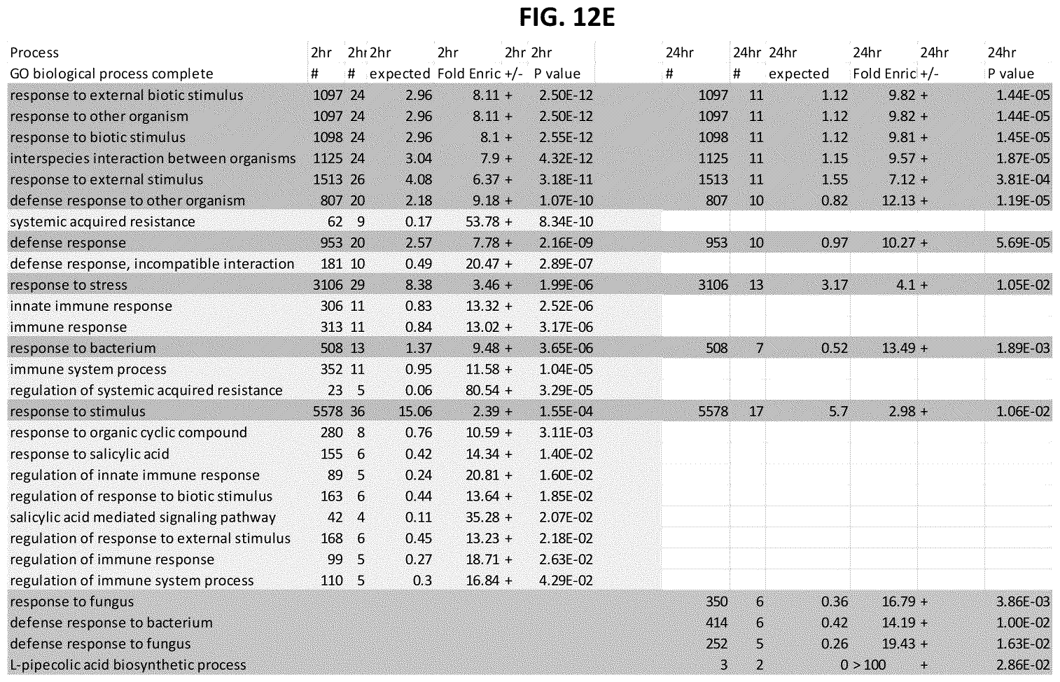

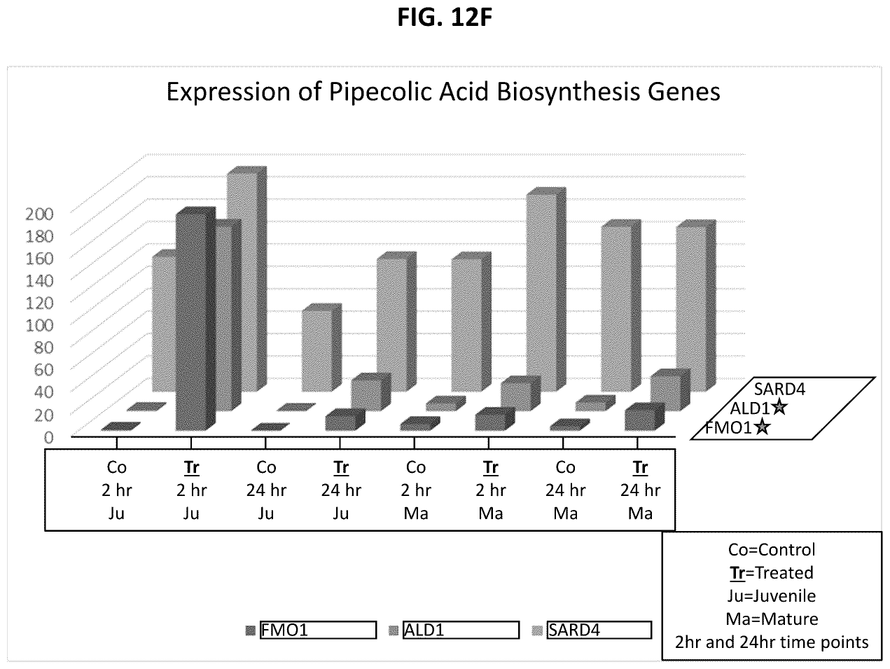

Treatment with an illustrative microalgae composition of the disclosure elicited large transcriptomic changes in both juvenile and mature Arabidopsis plants at both 2 and 24 hour time points (FIG. 12A). Juvenile and mature Arabidopsis plants showed very different transcriptional responses, with few shared up and down regulated genes (FIG. 12A). In juvenile leaves, genes involved in cell division were upregulated at 24 hours, while in mature leaves, cells involved in the response to stimulus and stress were upregulated (FIG. 12B). Examples of genes upregulated in juvenile plants at 2 hours are shown in FIG. 12C-D. At both timepoints in both juvenile and mature plants, genes involved in responses to other organisms were upregulated. In particular, shared upregulated genes between juvenile and mature plants were involved in: Systemic Acquired Resistance (“SAR”) at 2 hours; response to external biotic stimulus at 2 & 24 hours; and defense response to fungi and bacteria at 24 hours (FIG. 12E, shown for mature plants). Seven genes were upregulated in both plant types at both time points. Two out of seven of the genes were involved in pipecolic acid biosynthesis, and a third gene in the pipecolic acid biosynthesis pathway was upregulated in all conditions but the mature plant at 24 hours. Pipecolic acid is a key molecule in SAR. See FIG. 12F, which shows the expression of the three primary pipecolic acid biosynthesis genes in all eight tested conditions in Arabidopsis. As can be seen in this figure, all treated conditions had increased expression of ALD1 and FMO1 for both mature and juvenile plants. SARD4 was upregulated in all treated conditions except the 24 hour mature time point, at which point the expression in the treated condition was approximately equal to expression in the control condition.

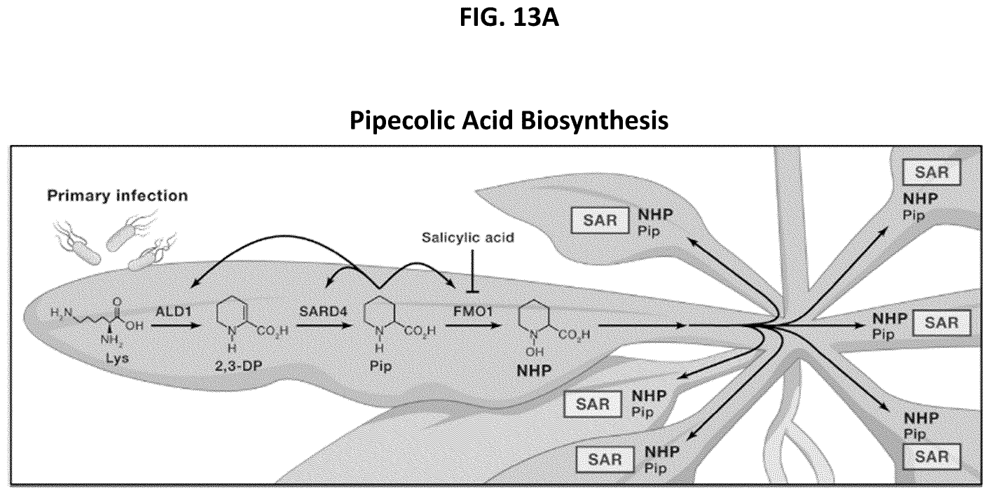

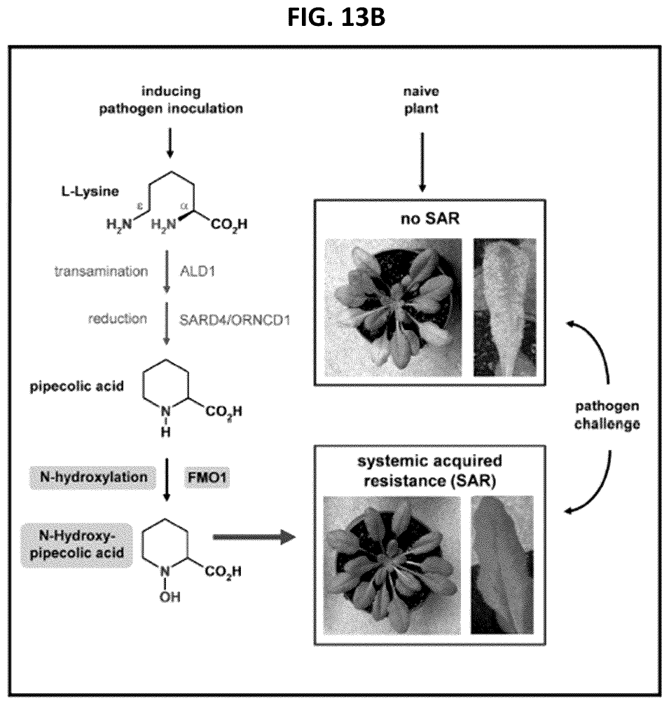

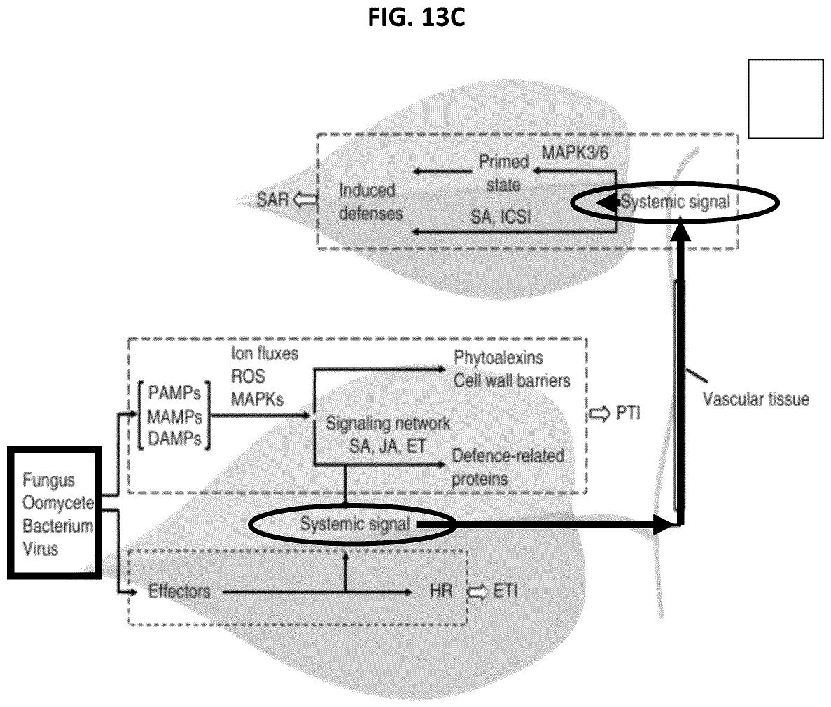

In plants, local infection by a pathogen can trigger systemic acquired resistance (SAR) in distal tissues, which helps to protect the plant from subsequent pathogen attacks. Upon infection, N-hydroxypipecolic acid (NHP) is generated by a three step biochemical pathway: (1) the Lys aminotransferase ALD1 converts L-Lys to 2,3-dehydropipecolic acid (2,3-DP); (2) the reductase SARD4 reduces 2,3-DP to pipecolic acid (Pip); and (3) Pip is N-hydroxylated by the monooxygenase FMO1 to generate NHP, a mediator of SAR. Both Pip and NHP accumulate in locally infected and distal leaves upon infection. Pip accumulation transcriptionally upregulates the expression of NHP biosynthesis genes, ALD1, SARD4, and FMOL. The plant hormone salicylic acid (SA), another key regulator of SAR, negatively regulates the conversion of Pip to NHP. FIG. 13A shows an overview of the pipecolic acid biosynthesis pathway leading to SAR. FIG. 13B demonstrates the development of SAR pictorially, showing a naïve plant challenged by pathogen in contrast to the same plant after repeat pathogen challenge (no administration of compositions of the disclosure). SAR develops after first exposure, helping the plant to protect itself in a subsequent exposure. FIG. 13C shows additional elements of signaling involved in the development of SAR following pathogenic attack.

The observed upregulation of each of ALD1, SARD4, and FMO1 in both mature and juvenile plants at almost all time points demonstrates a strong relationship between DMS application and SAR upregulation.

### RNAseq in Arabidopsis, Tomato, and Canola

Similar RNAseq experiments were repeated in Arabidopsis, tomato, and canola plants. SAR upregulation was observed in multiple plants at multiple timepoints. Upregulated genes involved with SAR included the following.

Molecular markers for systemic acquired resistance (SAR) such as Pathogenesis-Related Gene 1, 2 and 5 (At2g14610, At3g57260, At1g75040). Genes involved in defense response to bacterium and fungus such as Resistant To P. Syringae 2 (RPS2, At4g26090), Basic Chitinase (HCHIB, At3g12500) and Phospholipase A 2A (PLA2A, At2g26560). Genes involved in plant-parasitic nematode defense such as NILR1 (At1g74360), EXP16 (At3g55500) and At1g25275 were substantially activated. Key genes in the biosynthesis of salicylic acid appeared highly activated such as Isochorismate Synthase 1 (ICS1, At1g74710), Salicylic Acid Induction Deficient1 (SID1, At4g39030) and AVRPPHB Susceptible 3 (PBS3, At5g13320). Key genes in the Pipecolic Acid Biosynthesis were consistently activated in different treatments such as Flavin-Dependent Monooxygenase 1, FMO1 (At1g1250), AGD2-Like Defense Response Protein 1 (At2g13810), and SAR Deficient 4 (At5g52810).

### INCORPORATION BY REFERENCE

All references, articles, publications, patents, patent publications, and patent applications cited herein are incorporated by reference in their entireties for all purposes. However, mention of any reference, article, publication, patent, patent publication, and patent application cited herein is not, and should not be taken as an acknowledgment or any form of suggestion that they constitute valid prior art or form part of the common general knowledge in any country in the world.

### Numbered Embodiments of the Invention

Notwithstanding the appended claims, the disclosure sets forth the following numbered embodiments:
1. A method of bioprotection, the method comprising the step of:
   a) applying a microalgae-based composition to a host plant.
2. The method of embodiment 1, wherein the method improves host plant immunity.
3. The method of any one of embodiments 1-2, wherein the method upregulates the production of a gene involved in host plant immunity.
4. A method for improving host plant immunity against fungal infection, the method comprising the step of:
   a) applying a microalgae-based composition to the host plant.
5. A method for upregulating a host plant immune response against pathogenic infection
   a) applying a microalgae-based composition to the host plant.
6. The method of any one of embodiments 1-5, wherein the composition induces differential gene expression in juvenile versus mature host plants.
7. The method of any one of embodiments 1-6, wherein the composition is applied to a juvenile host plant.
8. The method of any one of embodiments 1-7, wherein the composition is applied to a juvenile host plant and induces upregulation of genes involved in cell division.
9. The method of any one of embodiments 1-8, wherein the composition is applied to a mature host plant.
10. The method of any one of embodiments 1-9, wherein the composition is applied to a mature host plant and induces upregulation of genes involved in response to stimulus and/or metabolic processes.
11. The method of any one of embodiments 1-10, wherein the method upregulates the plant host's Systemic Acquired Resistance (“SAR”).
12. The method of any one of embodiments 1-11, wherein the method upregulates the expression of genes involved in pipecolic acid biosynthesis.
12.1 The method of any one of embodiments 1-12, wherein the method upregulates the expression of ALD1, FMO1, and/or SARD4.
12.2 The method of any one of embodiments 1-12.1, wherein the method upregulates the expression of at least one of ALD1, FMO1, and SARD4.
12.3 The method of any one of embodiments 1-12.2, wherein the method upregulates the expression of each of ALD1, FMO1, and SARD4.
13. The method of any one of embodiments 1-12.3, wherein the microalgae-based composition does not have pathogenicidal activity.
14. The method of any one of embodiments 1-13, wherein the microalgae-based composition does not have fungicidal activity.
15. The method of any one of embodiments 1-14, wherein the infection is caused by a fungus, bacterium, protist, or virus.
16. The method of any one of embodiments 1-15, wherein the infection is caused by a fungus.
17. The method of any one of embodiments 1-16, wherein the infection is caused by a pathogen from a genus selected from the list consisting of: Albugo, Alternaria, Aphanomyces, Aschochyta, Aspergillus, Bipolaris, Blumeria, Botrytis, Cercospora, Colletotrichum, Didymella, Erysiphe, Fusarium, Leptosphaeria, Magnaporthe, Melampsora, Microdochium, Mycosphaerella, Peronospora, Phakopsora, Phytophthora, Plasmodiophora, Plasmopara, Puccinia, Pyrenophora, Pythium, Rhizoctonia, Rhizopus, Septoria, Sclerotium, Stemphylium, Tilletia, Uromyces, Ustilago, and Venturia.
18. The method of any one of embodiments 1-17, wherein the infection is caused by Ascochyta rabei, Alternaria carthami, Bipolaris sorokiana, Botrytis cinerea, Pyrenophora teres, or Rhizopus stolonifer.
19. The method of any one of embodiments 1-18, wherein the infection is in any plant part of the host plant.
20. The method of any one of embodiments 1-19, wherein the infection is in a root, leaf, fruit, or grain of the plant host.
21. The method of any one of embodiments 1-20, wherein the method suppresses or delays progression of the infection.
22. The method of any one of embodiments 1-21, wherein the method suppresses or delays progression of infection, as measured via an infection parameter selected from the list consisting of: size of necrotic tissue, lesion size, percent infection per leaf, percent infection per plant, and number of leaves infected per plant.
23. The method of any one of embodiments 1-22, wherein the method suppresses or delays progression of infection, as measured in comparison to a control plant without application of the microalgae composition.
24. The method of any one of embodiments 1-23, wherein the method comprises the additional step of: applying a fungicide and/or antibacterial to the host plant, separately or in combination with the microalgae-based composition.
25. The method of any one of embodiments 1-24, wherein the composition comprises multiple species of microalgae.
26. The method of any one of embodiments 1-25, wherein the composition comprises microalgae from a phylum selected from the list consisting of: Chlorophyta, Cryptophyta, Cyanophyta, Euglenophyta, Heterokontophyta, or Rhodophyta.
27. The method of any one of embodiments 1-26, wherein the composition comprises microalgae from a genus selected from the list consisting of: Chlorella, Scenedesmus, Nannochloropsis, Muriellopsis, Isochrysis, Tisochrysis, Desmodesmus, Haematococcus, Arthrospira, and Anabaena.
28. The method of any one of embodiments 1-27, wherein the composition comprises whole-cell microalgae powder.
29. The method of any one of embodiments 1-28, wherein the composition comprises 0.1-50 g/L of whole-cell microalgae powder.
30. The method of any one of embodiments 1-29, wherein the composition comprises 0.8-20 g/L of whole-cell microalgae powder.
31. The method of any one of embodiments 1-30, wherein the composition comprises digested microalgae solution (“DMS”).
32. The method of any one of embodiments 1-31, wherein the composition comprises 0.3-0.5% v/v DMS.
33. The method of any one of embodiments 1-32, wherein the composition comprises DMS, and the DMS comprises 5-20% dry matter of microalgae.
34. The method of any one of embodiments 1-33, wherein the composition comprises DMS, and the DMS comprises 5-20% dry matter of microalgae, and wherein the composition comprises DMS diluted to 0.3-0.5% v/v.
35. The method of any one of embodiments 1-34, wherein the composition is a liquid, and wherein the composition is applied at a rate of 0.5-20 L/ha.
36. The method of any one of embodiments 1-35, wherein the composition is a liquid, and wherein the composition is applied at a rate of 1-10 L/ha.
37. The method of any one of embodiments 1-36, wherein the composition is a granule composition, and wherein the composition is applied at a rate of 1-20 kg/ha.
38. The method of any one of embodiments 1-37, wherein the composition is a granule composition, and wherein the composition is applied at a rate of 5-15 kg/ha.
39. The method of any one of embodiments 1-38, wherein the host plant is an agronomical crop, a horticultural crop, or an ornamental crop.
40. The method of any one of embodiments 1-39, wherein the host plant is a monocot or dicot.
41. The method of any one of embodiments 1-40, wherein the host plant is an agronomical crop, a horticultural crop, or an ornamental plant.
42. The method of any one of embodiments 1-41, wherein the composition is a liquid and is applied to the whole plant, a plant part, and/or a plant cell.
43. The method of any one of embodiments 1-42, wherein the composition is applied as a spray to aerial plant parts and/or as a soil treatment to plant roots.
44. The method of any one of embodiments 1-43, wherein the composition comprises a cell free supernatant (“CFS”) of a microbial culture.
45. The method of any one of embodiments 1-44, wherein the composition comprises a CFS, and wherein the CFS is the isolated CFS of a mixed microbial culture comprising one or more microorganisms selected from the list consisting of: Aspergillus spp., Bacillus spp., Rhodopseudomonas spp., Candida spp., Lactobacillus spp., Lactococcus spp., Pseudomonas spp., Saccharomyces spp., Streptococcus spp., and combinations thereof.
46. The method of any one of embodiments 1-45, wherein the composition comprises a CFS, and wherein the CFS is the isolated CFS of a mixed microbial culture obtained from culturing IN-M1, deposited under ATCC Accession No. PTA-12383, or IN-M2, deposited under ATCC Accession No. PTA-121556.
47. The method of any one of embodiments 1-46, wherein the composition comprises a CFS, and wherein the CFS comprises at least 2500 micrograms potassium per gram, at least 435 micrograms nitrogen per gram, at least 475 micrograms calcium per gram, and/or at least 200 micrograms magnesium per gram.
48. The method of any one of embodiments 1-47, wherein the composition comprises a CFS, and wherein the CFS comprises a CFS of a mixed microbial culture that has been diluted between 1:50 and 1:2000 with water.
49. The method of any one of embodiments 1-48, wherein the composition comprises a CFS, and wherein the CFS comprises about 2% dry matter.
50. The method of any one of embodiments 1-49, wherein the composition comprises a CFS, and wherein the composition comprises about 0.005-0.05% w/w CFS dry matter.
51. The method of any one of embodiments 1-50, wherein the composition comprises a CFS, and wherein the composition comprises microalgae in the form of DMS, and wherein the ratio of DMS to CFS is between 1:4 and 4:1.
52. The method of any one of embodiments 1-51, wherein the composition comprises a CFS, and wherein the composition comprises microalgae in the form of DMS, wherein the ratio of DMS to CFS is between 1:4 and 4:1, and wherein the composition comprises the combination of DMS and CFS diluted to 0.3-0.5% v/v in water.
53. The method of any one of embodiments 1-52, wherein the composition comprises a CFS, and wherein the composition comprises microalgae in the form of DMS, and wherein the ratio of DMS to CFS is 1:4 or 2:3.
54. A bioprotection composition comprising:
   a) a microalgae-based composition; and
   b) a pathogenicidal agent.
55. The composition of embodiment 54, wherein the composition comprises a pesticide, fungicide, insecticide, herbicide, nematicide, bactericide, or antimicrobial.
56. The composition of any one of embodiments 54-55, wherein the composition comprises a fungicide.
57. The composition of any one of embodiments 54-56, wherein the composition comprises a microbial agent that has pathogenicidal properties.
58. The composition of any one of embodiments 54-57, wherein the composition comprises a cell free supernatant (“CFS”) of a microbial culture.
59. The composition of any one of embodiments 54-58, wherein the composition comprises a CFS, and wherein the CFS is the isolated CFS of a mixed microbial culture comprising one or more microorganisms selected from the list consisting of: Aspergillus spp., Bacillus spp., Rhodopseudomonas spp., Candida spp., Lactobacillus spp., Lactococcus spp., Pseudomonas spp., Saccharomyces spp., Streptococcus spp., and combinations thereof.
60. The composition of any one of embodiments 54-59, wherein the composition comprises a CFS, and wherein the CFS is the isolated CFS of a mixed microbial culture obtained from culturing IN-M1, deposited under ATCC Accession No. PTA-12383, or IN-M2, deposited under ATCC Accession No. PTA-121556.
61. The composition of any one of embodiments 54-60, wherein the composition comprises a CFS, and wherein the CFS comprises at least 2500 micrograms potassium per gram, at least 435 micrograms nitrogen per gram, at least 475 micrograms calcium per gram, and/or at least 200 micrograms magnesium per gram.
62. The composition of any one of embodiments 54-61, wherein the composition comprises a CFS, and wherein the CFS comprises a CFS of a mixed microbial culture that has been diluted between 1:50 and 1:2000 with water.
63. The composition of any one of embodiments 54-62, wherein the composition comprises a CFS, and wherein the CFS comprises about 2% dry matter.
64. The composition of any one of embodiments 54-63, wherein the composition comprises a CFS, and wherein the composition comprises about 0.005-0.05% w/w CFS dry matter.
65. The composition of any one of embodiments 54-64, wherein the composition comprises a CFS, and wherein the composition comprises microalgae in the form of DMS, and wherein the ratio of DMS to CFS is between 1:4 and 4:1.
66. The composition of any one of embodiments 54-65, wherein the composition comprises a CFS, and wherein the composition comprises microalgae in the form of DMS, wherein the ratio of DMS to CFS is between 1:4 and 4:1, and wherein the composition comprises the combination of DMS and CFS diluted to 0.3-0.5% v/v in water.
67. The composition of any one of embodiments 54-66, wherein the composition comprises a CFS, and wherein the composition comprises microalgae in the form of DMS, and wherein the ratio of DMS to CFS is 1:4 or 2:3.
68. The composition of any one of embodiments 54-67, wherein the composition comprises multiple species of microalgae.
69. The composition of any one of embodiments 54-68, wherein the composition comprises microalgae from a phylum selected from the list consisting of: Chlorophyta, Cryptophyta, Cyanophyta, Euglenophyta, Heterokontophyta, or Rhodophyta.
70. The composition of any one of embodiments 54-69, wherein the composition comprises microalgae from a genus selected from the list consisting of: Chlorella, Scenedesmus, Nannochloropsis, Muriellopsis, Isochrysis, Tisochrysis, Desmodesmus, Haematococcus, Arthrospira, and Anabaena.
71. The composition of any one of embodiments 54-70, wherein the composition comprises whole-cell microalgae powder.
72. The composition of any one of embodiments 54-71, wherein the composition comprises 0.1-50 g/L of whole-cell microalgae powder.
73. The composition of any one of embodiments 54-72, wherein the composition comprises 0.8-20 g/L of whole-cell microalgae powder.
74. The composition of any one of embodiments 54-73, wherein the composition comprises digested microalgae solution (“DMS”).
75. The composition of any one of embodiments 54-74, wherein the composition comprises 0.3-0.5% v/v DMS.
76. The composition of any one of embodiments 54-75, wherein the composition comprises DMS, and the DMS comprises 5-20% dry matter of microalgae.
77. The composition of any one of embodiments 54-76, wherein the composition comprises DMS, and the DMS comprises 5-20% dry matter of microalgae, and wherein the composition comprises DMS diluted to 0.3-0.5% v/v.
78. A bioprotection method comprising applying the composition of any one of embodiments 54-77 to a host plant.

1. A method of bioprotection, the method comprising the step of:
a) applying a microalgae-based composition to a host plant.

2. The method of claim 1, wherein the method improves host plant immunity and/or upregulates the production of a gene involved in host plant immunity.

3. A method for improving host plant immunity against fungal infection, the method comprising the step of:
a) applying a microalgae-based composition to the host plant.

4. A method for upregulating a host plant immune response against pathogenic infection
a) applying a microalgae-based composition to the host plant.

5. The method of any one of claims 1-4, wherein the composition induces differential gene expression in juvenile versus mature host plants.

6. The method of any one of claims 1-4, wherein the composition is applied to a juvenile host plant, optionally wherein application induces upregulation of genes involved in cell division.

7. The method of any one of claims 1-4, wherein the composition is applied to a mature host plant, optionally wherein application induces upregulation of genes involved in response to stimulus and/or metabolic processes.

8. The method of any one of claims 1-4, wherein the method upregulates the plant host's Systemic Acquired Resistance (“SAR”).

9. The method of any one of claims 1-4, wherein the method upregulates the expression of genes involved in pipecolic acid biosynthesis.

10. The method of any one of claims 1-4, wherein the method upregulates the expression of ALD1, FMO1, and/or SARD4.

11. The method of any one of claims 1-4, wherein the microalgae-based composition does not have pathogenicidal activity, optionally wherein the microalgae-based composition does not have fungicidal activity.

12. The method of claim 4, wherein the infection is caused by a fungus, bacterium, protist, or virus.

13. The method of claim 4, wherein the infection is caused by a fungus.

14. The method of claim 3 or 4, wherein the infection is caused by a pathogen from a genus selected from the list consisting of: Albugo, Alternaria, Aphanomyces, Aschochyta, Aspergillus, Bipolaris, Blumeria, Botrytis, Cercospora, Colletotrichum, Didymella, Erysiphe, Fusarium, Leptosphaeria, Magnaporthe, Melampsora, Microdochium, Mycosphaerella, Peronospora, Phakopsora, Phytophthora, Plasmodiophora, Plasmopara, Puccinia, Pyrenophora, Pythium, Rhizoctonia, Rhizopus, Septoria, Sclerotium, Stemphylium, Tilletia, Uromyces, Ustilago, and Venturia.

15. The method of claim 3 or 4, wherein the infection is caused by Ascochyta rabei, Alternaria carthami, Bipolaris sorokiana, Botrytis cinerea, Pyrenophora teres, or Rhizopus stolonifer.

16. The method of claim 3 or 4, wherein the infection is in any plant part of the host plant, optionally wherein the infection is in a root, leaf, fruit, or grain of the plant host.

17. The method of claim 3 or 4, wherein the method suppresses or delays progression of the infection, optionally wherein progression is measured via an infection parameter selected from the list consisting of: size of necrotic tissue, lesion size, percent infection per leaf, percent infection per plant, and number of leaves infected per plant.

18. The method of claim 3 or 4, wherein the method suppresses or delays progression of infection, as measured in comparison to a control plant without application of the microalgae composition.

19. The method of any one of claims 1-4, wherein the method comprises the additional step of: applying a fungicide and/or antibacterial to the host plant, separately or in combination with the microalgae-based composition.

20. The method of any one of claims 1-4, wherein the composition comprises multiple species of microalgae.

21. The method of any one of claims 1-4, wherein the composition comprises microalgae from a phylum selected from the list consisting of: Chlorophyta, Cryptophyta, Cyanophyta, Euglenophyta, Heterokontophyta, or Rhodophyta, optionally wherein the composition comprises microalgae from a genus selected from the list consisting of: Chlorella, Scenedesmus, Nannochloropsis, Muriellopsis, Isochrysis, Tisochrysis, Desmodesmus, Haematococcus, Arthrospira, and Anabaena.

22. The method of any one of claims 1-4, wherein the composition comprises whole-cell microalgae powder, optionally wherein the composition comprises 0.1-50 g/L or 0.8-20 g/L of whole-cell microalgae powder.

23. The method of any one of claims 1-4, wherein the composition comprises digested microalgae solution (“DMS”), optionally wherein the composition comprises:
a) 0.3-0.5% v/v DMS and/or
b) 5-20% dry matter of microalgae.

24. The method of any one of claims 1-4, wherein the composition is a liquid, and wherein the composition is applied at a rate of 0.5-20 L/ha or 1-10 L/ha.

25. The method of any one of claims 1-4, wherein the composition is a granule composition, and wherein the composition is applied at a rate of 1-20 kg/ha or 5-15 kg/ha.

26. The method of any one of claims 1-4, wherein the host plant is an agronomical crop, a horticultural crop, or an ornamental crop, optionally wherein the host plant is a monocot or dicot.

27. The method of any one of claims 1-4, wherein the composition is a liquid and is applied to the whole plant, a plant part, and/or a plant cell, optionally wherein the composition is applied as a spray to aerial plant parts and/or as a soil treatment to plant roots.

28. The method of any one of claims 1-4, wherein the composition comprises a cell free supernatant (“CFS”) of a microbial culture.

29. The method of any one of claims 1-4, wherein the composition comprises a CFS, and wherein the CFS comprises:
a) the isolated CFS of a mixed microbial culture comprising one or more microorganisms selected from the list consisting of: Aspergillus spp., Bacillus spp., Rhodopseudomonas spp., Candida spp., Lactobacillus spp., Lactococcus spp., Pseudomonas spp., Saccharomyces spp., Streptococcus spp., and combinations thereof;
b) the isolated CFS of a mixed microbial culture obtained from culturing IN-M1, deposited under ATCC Accession No. PTA-12383, or IN-M2, deposited under ATCC Accession No. PTA-121556;
c) at least 2500 micrograms potassium per gram, at least 435 micrograms nitrogen per gram, at least 475 micrograms calcium per gram, and/or at least 200 micrograms magnesium per gram;
d) a CFS of a mixed microbial culture that has been diluted between 1:50 and 1:2000 with water; and/or
e) about 2% dry matter.

30. The method of any one of claims 1-4, wherein the composition comprises a CFS, and wherein the composition comprises about 0.005-0.05% w/w CFS dry matter.

31. The method of any one of claims 1-4, wherein the composition comprises a CFS, and wherein the composition comprises microalgae in the form of DMS, and wherein the ratio of DMS to CFS is between 1:4 and 4:1, optionally wherein the composition comprises the combination of DMS and CFS diluted to 0.3-0.5% v/v in water.

32. The method of any one of claims 1-4, wherein the composition comprises a CFS, and wherein the composition comprises microalgae in the form of DMS, and wherein the ratio of DMS to CFS is 1:4 or 2:3.

33. A bioprotection composition comprising:
a) a microalgae-based composition; and
b) a pathogenicidal agent.

34. The composition of claim 33, wherein the composition comprises a pesticide, fungicide, insecticide, herbicide, nematicide, bactericide, or antimicrobial.

35. The composition of claim 33, wherein the composition comprises a fungicide.

36. The composition of claim 33, wherein the composition comprises a microbial agent that has pathogenicidal properties.

37. The composition of claim 33, wherein the composition comprises a cell free supernatant (“CFS”) of a microbial culture.

38. The composition of claim 33, wherein the composition comprises a CFS, and wherein the CFS comprises:
a) the isolated CFS of a mixed microbial culture comprising one or more microorganisms selected from the list consisting of: Aspergillus spp., Bacillus spp., Rhodopseudomonas spp., Candida spp., Lactobacillus spp., Lactococcus spp., Pseudomonas spp., Saccharomyces spp., Streptococcus spp., and combinations thereof;
b) the isolated CFS of a mixed microbial culture obtained from culturing IN-M1, deposited under ATCC Accession No. PTA-12383, or IN-M2, deposited under ATCC Accession No. PTA-121556;
c) at least 2500 micrograms potassium per gram, at least 435 micrograms nitrogen per gram, at least 475 micrograms calcium per gram, and/or at least 200 micrograms magnesium per gram;
d) a CFS of a mixed microbial culture that has been diluted between 1:50 and 1:2000 with water; and/or
e) about 2% dry matter.

39. The composition of claim 33, wherein the composition comprises a CFS, and wherein the composition comprises about 0.005-0.05% w/w CFS dry matter.

40. The composition of claim 33, wherein the composition comprises a CFS, and wherein the composition comprises microalgae in the form of DMS, and wherein the ratio of DMS to CFS is between 1:4 and 4:1, optionally wherein the composition comprises the combination of DMS and CFS diluted to 0.3-0.5% v/v in water.

41. The composition of claim 33, wherein the composition comprises a CFS, and wherein the composition comprises microalgae in the form of DMS, and wherein the ratio of DMS to CFS is 1:4 or 2:3.

42. The composition of claim 33, wherein the composition comprises multiple species of microalgae.

43. The composition of claim 33, wherein the composition comprises microalgae from a phylum selected from the list consisting of: Chlorophyta, Cryptophyta, Cyanophyta, Euglenophyta, Heterokontophyta, or Rhodophyta.

44. The composition of claim 33, wherein the composition comprises microalgae from a genus selected from the list consisting of: Chlorella, Scenedesmus, Nannochloropsis, Muriellopsis, Isochrysis, Tisochrysis, Desmodesmus, Haematococcus, Arthrospira, and Anabaena.

45. The composition of claim 33, wherein the composition comprises whole-cell microalgae powder, optionally wherein the composition comprises 0.1-50 g/L or 0.8-20 g/L of whole-cell microalgae powder.

46. The composition of claim 33, wherein the composition comprises digested microalgae solution (“DMS”).

47. The composition of claim 33, wherein the composition comprises 0.3-0.5% v/v DMS.

48. The composition of claim 33, wherein the composition comprises DMS, and the DMS comprises 5-20% dry matter of microalgae.

49. The composition of claim 33, wherein the composition comprises DMS, and the DMS comprises 5-20% dry matter of microalgae, and wherein the composition comprises DMS diluted to 0.3-0.5% v/v.

50. A bioprotection method comprising applying the composition of any one of claims 33-49 to a host plant.
